(19) United States
(12) Patent Application Publication
(10) Pub. No.: US 2025/0080318 A1
(43) Pub. Date: Mar. 6, 2025

(54) HOMOMORPHIC ENCRYPTION FOR ONLINE VOTING

(71) Applicant: Zoho Corporation Private Limited, Kanchipuram District (IN)

(72) Inventors: Naveen Seenivasagam, Chennai (IN); Panimalar Aravindan, Chennai (IN); Nandini Malhotra, Hyderabad (IN); Keerthana Sethuraman Mallika, Chennai (IN); Ramprakash Ramamoorthy, Singaperumal Koil (IN); Shailesh Kumar Davey, Kanchipuram District (IN)

(73) Assignee: Zoho Corporation Private Limited, Kanchipuram District (IN)

(21) Appl. No.: 18/799,064

(22) Filed: Aug. 9, 2024

Related U.S. Application Data
(60) Provisional application No. 63/590,539, filed on Oct. 16, 2023.

(30) Foreign Application Priority Data
Aug. 30, 2023 (IN) 202341058263
May 15, 2024 (IN) 202441038263

(51) Int. Cl. H04L 9/00; G07C 13/00

(52) U.S. Cl. CPC H04L 9/008; G07C 13/00

(57) ABSTRACT

Encrypted poll responses from a group of users are validated homomorphically in an online polling system. Mathematical operations are performed on encrypted poll responses to produce validated encrypted results. The operations, when applied to plaintext of the encrypted poll response, normalize the plaintext when the poll response is valid, and nullify the plaintext when the poll response is invalid. The validated encrypted poll responses can be analyzed, without decryption, to provide a variety of results in encrypted format. The analysis may include summing the validated poll responses to produce a tally and may also be analyzed in accordance with associated cleartext metadata. Multiple sets of encrypted poll responses to multiple poll queries can be analyzed to determine relationships with respect to each other, in encrypted form, as well as in conjunction with cleartext parameters.

### FIELD OF THE INVENTION

Embodiments of the present disclosure are related, in general, to online polling and more particularly, but not exclusively, to homomorphic validation and analysis of encrypted poll responses.

### CROSS REFERENCE TO RELATED APPLICATIONS

This application is related to Indian Provisional Application 202341058263 filed 30 Aug. 2023 and U.S. Provisional Application 63/590,539 filed 16 Oct. 2023, both entitled “METHODS AND SYSTEM FOR VALIDATING AND ANALYSIS OF ANONYMOUS VOTES USING HOMOMORPHIC ENCRYPTION”, and Indian Provisional Application 202441038263 filed 15 May 2024, entitled “HOMOMORPHIC ENCRYPTION FOR ONLINE VOTING”, all of which are incorporated herein by reference.

### BACKGROUND

Online voting systems exist to facilitate distributed, convenient, safe, and secure voting access to a population of users. Voting is but one example of online polling, in which a poll may contain any number of poll questions, and wherein each user replies to those queries with a poll response. A polling system should provide for secure and accurate responses from identity-authenticated users who are authorized to participate in a particular poll. Prior-art voting systems have provided for homomorphic encryption of poll responses, which allows summation of the encrypted poll responses, without decrypting, to provide an encrypted set of results for each candidate. Poll analysis, including total vote count of candidate responses, should be performed on responses that have been validated, to provide accurate and untampered results. The prior art requires additional procedures to validate homomorphically encrypted poll responses, such as providing accompanying partial and zero knowledge proofs. It is beneficial to have a polling system without the need for such proofs. Additionally, in some polling systems, it will be desirable to provide privacy and/or anonymity to users or voters responding to polls.

### BRIEF DESCRIPTION OF THE DRAWINGS

The subject matter disclosed is illustrated by way of example, and not by way of limitation, in the figures of the accompanying drawings and in which like reference numerals refer to similar elements and in which:

The subject matter disclosed is illustrated by way of example, and not by way of limitation, in the figures of the accompanying drawings and in which like reference numerals refer to similar elements and in which:

FIG. 1 illustrates how source code FIG. 1 depicts system 100 illustrating homomorphic analysis 120 of encrypted poll responses to produce an encrypted result 130 for a poll.

FIG. 2 illustrates homomorphic validation 220 of encrypted poll responses 110, resulting in corresponding validated encryption poll responses 210.

FIG. 3 illustrates a ballot 300 for a poll, along with several example poll responses 310, and their cleartext encoding.

FIG. 4 shows an example scheme 400 for encryption, decryption, and homomorphic computing useful for performing validation and analysis of encrypted poll responses.

FIG. 5 identifies example homomorphic operations suitable for operating on E(m) to produce f(c), which is also represented as E(f(m)).

FIG. 6 is a flowchart depicting an example method 600 of validating encrypted poll responses to produce encrypted validated poll responses.

FIG. 7 includes table 700 illustrating method 600 applied to sample encrypted poll responses.

FIG. 8 is a system 800 which illustrates homomorphic analysis of encrypted poll responses in accordance with cleartext metadata.

FIG. 9 is a flowchart 900 illustrating analyzing validated votes to produce a sum of poll responses based on a cleartext parameter.

FIG. 10 is a flowchart 1000 illustrating a method for homomorphic computing of the total response to a poll.

FIG. 11 is a flowchart 1100 illustrating a method for homomorphic analysis of poll data using multiple cleartext parameters to return sum vectors for each of those parameters.

FIG. 12 is a system 1200 which illustrates homomorphic analysis of encrypted poll responses in accordance with cleartext metadata parameters, where parameters are encrypted for use in homomorphic computation of the encrypted poll results.

FIG. 13 is a flowchart 1300 illustrating a method for homomorphic analysis of poll results with encrypted metadata parameters.

FIG. 14 is a table with example results illustrating the method of FIG. 13.

FIG. 15 is a system 1500 which illustrates homomorphic analysis of the relationship between one or more sets of encrypted poll responses.

FIG. 16 is a flowchart illustrating a method 1600 for analyzing the relationship between sets of encrypted responses to questions in a poll, such as described in FIG. 15.

FIG. 17 includes tables 1700 and 1710 with example results illustrating one embodiment of method 1600.

FIG. 18 is a flowchart illustrating a method 1800, an example embodiment of method 1600 or for use in homomorphic parameter analysis unit 1530.

FIGS. 19A and 19B include table 1900 with example results illustrating one embodiment of method 1800.

FIG. 20 is an example polling system 2000.

FIG. 21 illustrates a process flow 2100 for polling system 2000.

FIG. 22 is a flowchart 2200 illustrating an example poll creation process.

FIG. 23 is a flowchart 2300 illustrating a process for online poll response (voting) by a user.

FIG. 24 (prior art) depicts a general-purpose computing system 2400 that can serve as a client or a server depending on the program modules and components included.

### DETAILED DESCRIPTION

Encrypted poll responses from a group of users are validated homomorphically in an online polling system. The validated encrypted poll responses can be analyzed, without decryption, to provide a variety of results in encrypted format.

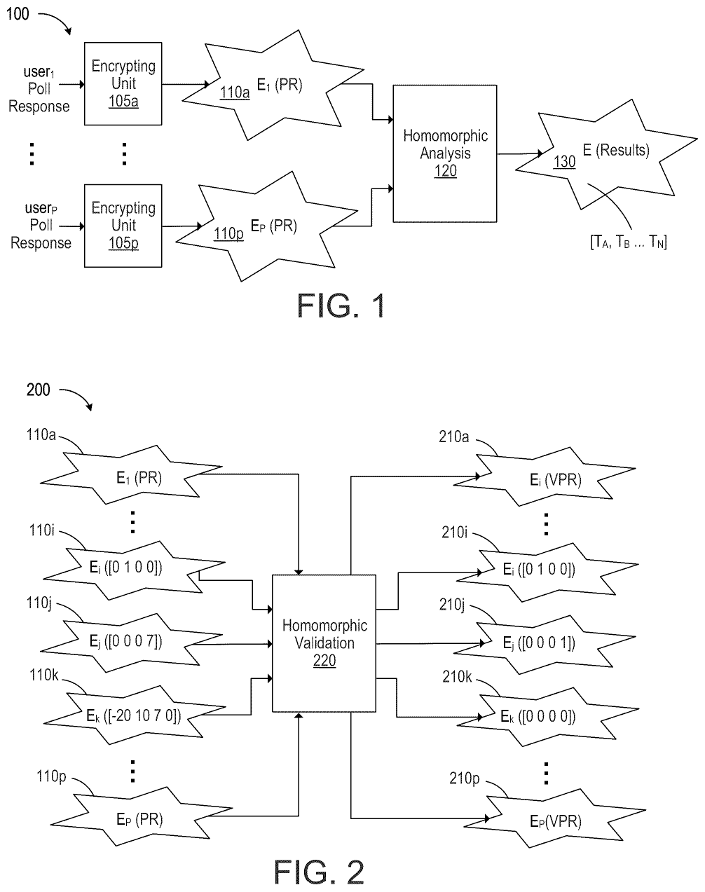

FIG. 1 depicts system 100 illustrating homomorphic analysis 120 of encrypted poll responses to produce an encrypted result 130 for a poll. A group of P users, user₁ to userₚ, respond to a poll, and the poll responses are encrypted in encrypting units 105a to 105p to produce encrypted poll responses 110a to 110p, E₁(PR) to Eₚ(PR), respectively. The encrypted results are modified using homomorphic computation, meaning the computation is carried out on encrypted values without decrypting, any intermediate values remain encrypted, and the results (130) are delivered encrypted as well. In one embodiment, detailed further below, homomorphic computation on the encrypted poll results is carried out on a server that does not have the decryption key. The results in one example are the homomorphic addition of votes for one of N candidates (A to N), the totals denoted T_{A} . . . T_{N}, the results being encryption 130 of those results (labeled E(Results)) to denote that the results are an encryption, that, if decrypted, would yield results T_{A} . . . T_{N}. In the figures herein, a star outline in a block diagram indicates ciphertext (or ciphertext computations), and E(X) represents an encryption such that it, if decrypted, would yield X.

FIG. 2 illustrates homomorphic validation 220 of encrypted poll responses 110, resulting in corresponding validated encryption poll responses 210. Homomorphic validation is useful for homomorphic analysis, such as the addition of votes, just described, and useful for performing a variety of other analytics also, detailed further below. Here, each of the P encrypted poll responses E₁(PR) to Eₚ(PR) are homomorphically validated to produce validated poll responses E₁(VPR) . . . Eₚ(VPR), 210a to 210p, respectively. Validation is carried out by a processing device performing a mathematical operation on the encrypted data corresponding to an operation that, when applied to plaintext data, produces the desired result. That desired result may be to change, normalize, or nullify the poll result. The following example serves to illustrate.

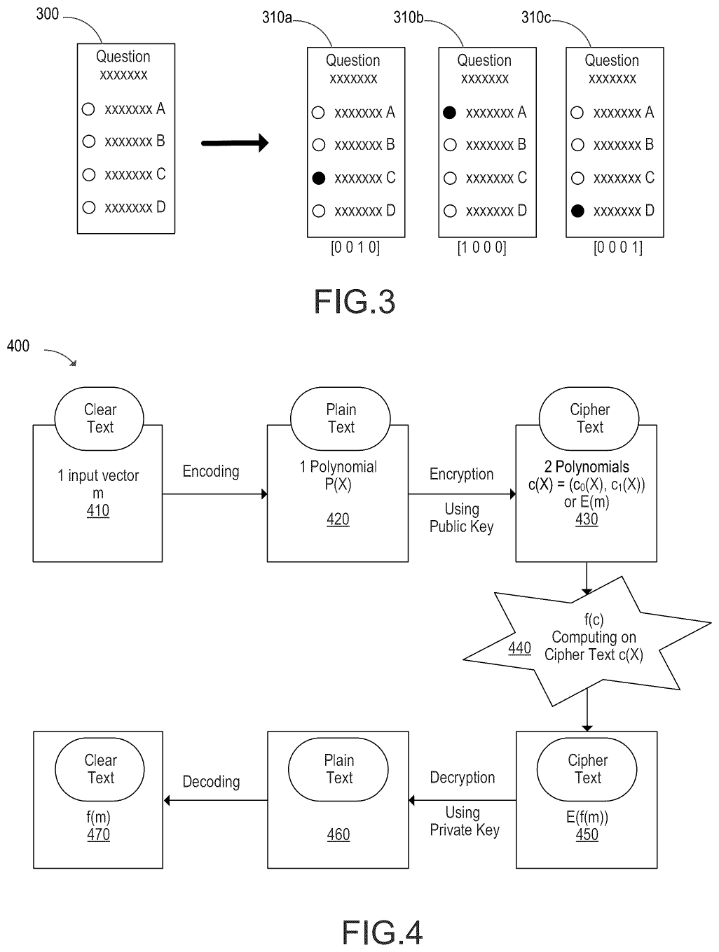

FIG. 3 illustrates a ballot 300 for a poll, along with several example poll responses 310, and their cleartext encoding. A poll could include a list of candidates from which users select their choice. A poll can include any other type of question, or questions. There will be N possible answers for each poll query. Here, ballot 300 has a question, and there are four possible answer choices. Users can select only one choice. In this example, a vote for candidates in an election, each vote is encoded in a vector sized to hold one value for each candidate. So, a vote 310a for candidate C results in a vector of all zeros except a one in the third position: [0 0 1 0]. Similarly, a vote 310b for candidate A or a vote 310c for candidate D results in response vectors [1 0 0 0] and [0 0 0 1], respectively, as shown.

Returning to FIG. 1, a simple analysis to perform is to sum the encrypted poll responses to determine the total number of responses selecting each of a variety of candidates. It's clear that with the encoding method for ballots 310, simply adding them together produces a tally in each vector position for the respective candidate. The property of homomorphic addition yields an encrypted version of the same tally vector when the encrypted poll responses are summed. For example, imagine a group of P=161 voters, casting 42 votes for candidate A, 73 for candidate B, 19 for candidate C, and 27 for candidate D. The plaintext arithmetic for the voting totals would be 42×[10 0 0]+73×[0 10 0]+19×[0 0 1 0]+27×[0 0 0 1]. The votes, encoded, encrypted, and homomorphically summed, yield the result E([42 73 19 27]), wherein each column is the respective total for candidates A through D.

It would be common practice for software running on a user terminal to be designed to present users with a poll of one or more queries or electoral ballots, receive the user's choices, and encode and encrypt only valid responses. Therefore, no validation would be required. However, a user with certain skill may be able to generate an invalid vote, encode and encrypt it, and introduce it into the polling system to produce unfair or undesirable results. Examples include voting for more than one candidate when that is disallowed, overweighting a candidate, underweighting a candidate, or some combination of these.

Returning to FIG. 2, consider the three example encrypted poll responses 110i, 110j, and 110k. Encrypted poll response 110i is a valid response, Eᵢ[0 1 0 0], the second choice selected out of four total. Encrypted poll response 110j, Eⱼ[0 0 0 7] is an example invalid poll response overweighting the fourth choice. Encrypted poll response 110k, Eₖ[−20 10 7 0], is invalid, subtracting 20 from candidate A and overweighting both candidates B and C. Following homomorphic validation, the three examples have three different illustrative outcomes. The first validated encrypted output 210i is the same as the input, namely Eᵢ([0 0 0 1]), because the input was originally a valid response. The second, 210j, has been normalized. While the input was an overweight choice and invalid, that input can be normalized to a valid vote of the proper magnitude, Eⱼ([0 0 0 1]). The third input, 210k, having multiple inputs, is nullified, with all values replaced by zeros, Eₖ([0 0 0 0]). While three differing outcomes for three example inputs have been illustrated, the validation procedure is the same for all the input poll responses. Although all the validated outputs have been either passed through as they were (valid votes), normalized (overweight in one choice), or nullified (zeroed out), since all the computation takes place on ciphertext, there is no way of knowing which input has been nullified, normalized, or passed through.

Having performed this validation on the inputs, the validated outputs can now be processed further homomorphically, for example in homomorphic analysis 120. Since there is no way to know which responses have been nullified, all of them are processed in various analysis procedures. In the example given with respect to FIG. 1, all the validated poll responses can now be summed to produce the tally of responses, or votes, for each candidate. The nullified votes will also be included in the sum, but since they are an encryption of the additive identity (zeros in this example), and an additive identity themselves in ciphertext, they do not alter the summation. Validation and nullification can thus be performed on all the poll responses without needing to identify which, if any, are invalid.

Returning to FIG. 1, a simple analysis is to perform is to sum the encrypted poll responses to determine the total number of responses selecting each of a variety of candidates. Various other analyses are detailed further below, including using associated metadata associated with a group of users. Other alternatives, such as weighted voting, can be accomplished by allowing additional votes per user, and validating each additional response independently.

FIG. 4 shows an example scheme 400 for encryption, decryption, and homomorphic computing useful for performing validation and analysis of encrypted poll responses. There are various schemes available in homomorphic encryption ranging from leveled to bootstrappable schemes. Leveled schemes limit the number of multiplications that can be performed with a predefined depth, while bootstrappable schemes reduce the noise in ciphertext on demand, so theoretically any number of operations can be performed. However, the bootstrapping process can be computationally expensive.

The example embodiment of FIG. 4 uses the CKKS (Cheon-Kim-Kim-Song) scheme. For poll responses, and general counting, a leveled homomorphic mode is used. In other analysis, as the application demands, bootstrapping is used. CKKS is based on an asymmetric key encryption mechanism. In addition to a public key and the private key, Galois and relinearization keys are also generated. Using the parameters polynomial degree N and coefficient modulus “q”, the secret key polynomial “s”, relinearization key, Galois key and the public key polynomial pair (a, b=−a.s+e), where “a” is a randomly generated polynomial whose coefficients are chosen from a uniform distribution and “e” is a randomly sampled error polynomial whose coefficients are chosen from Gaussian distribution, using the concept of ring learning with errors. The private key is kept secret with the owner of the key-pair generator and the public key is published to all other users in the environment. The Galois and relinearization keys are used in certain homomorphic computation.

A cleartext input is an input vector 410, such as poll responses 310 detailed above. The vector 410 is a message m of size N/2. The cleartext input vector is encoded into a plaintext polynomial P(X) 420, with integer coefficients modulo q (i.e., of the domain Z_{q}[x]/(1+X^{N})) P(X) 420. This encoded polynomial is then encrypted into ciphertext 430 using the published public key, c=(m+b, a), in the form of a pair of ciphertexts, c(X)=c₀(X),c₁(X). The use of the terminology cleartext and plaintext identifies the difference between text-based data and encoded text-based data, respectively. In a broader sense, both terms identify non-encrypted data, in contrast to encrypted data, or ciphertext. When the distinction between encoded or nonencoded data is not necessary, the terms plaintext and cleartext can be, and often are, used interchangeably.

The ciphertext can be subjected to a variety of mathematical computations 440. For example, consider a function f(m). The same function includes any number of homomorphic operations on the ciphertext to produce f(c), which is an encryption of f(m). The function f is applied on the ciphertext, and the result f(c) is computed homomorphically.

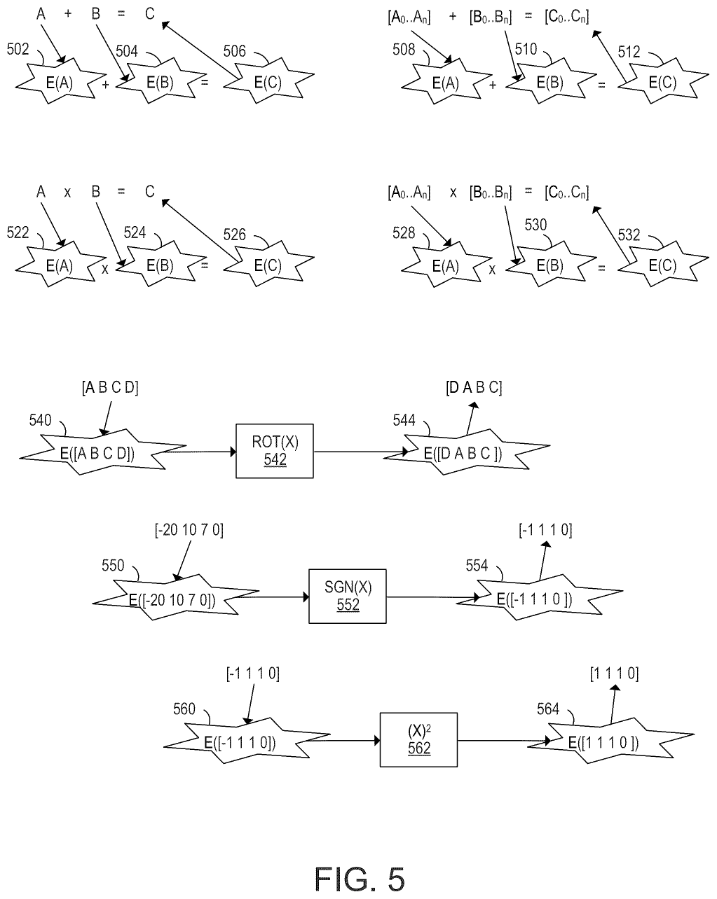

FIG. 5 identifies example homomorphic operations suitable for operating on E(m) to produce f(c), which is also represented as E(f(m)). In an example embodiment, operations are combined for manipulating encrypted poll responses for validation and analysis. Their use is detailed in various embodiments below.

Homomorphic addition is one operation. Consider two variables A and B, added in cleartext to form the sum C, A+B=C. With the additive homomorphic property, E(A) 502+E(B) 504 sums to E(A+B)=E(C) 506. Decrypting E(C) 506 yields the plaintext C. Similarly, in cleartext, vectors [A₀ . . . Aₙ]+[B₀ . . . Bₙ]=[C₀ . . . Cₙ]. It then follows that E(A) 508+E(B) 510=E(A+B)=E(C) 512. Decrypting E(C) yields plaintext [C₀ . . . Cₙ]. In the CKKS example, adding two ciphertexts, c=(c0,c1) and c′=(c0′,c1′) results in sum (c0+c0′,c1+c1′). Note, the additive identity 0 in cleartext encodes to a non-zero polynomial in ciphertext, but the homomorphic properties operate such that the encrypted representation of 0 is also an additive identity in the encryption domain.

Homomorphic multiplication is another operation. When A×B=C in cleartext, then E(A) 522×E(B) 524=E(A×B)=E(C) 526. With cleartext vectors, [A₀ . . . Aₙ]×[B₀ . . . Bₙ]=[C₀ . . . Cₙ]. And so E(A) 528×E(B) 530=E(A×B)=E(C) 532, which decrypts to [C₀ . . . Cₙ]. With CKKS, multiplying two ciphertexts c=(c0,c1) and c′=(c0′,c1′) yields (c0×c′0, c0×c′1+c′0×c1, c1×c′1), which includes the desired multiplication results plus a third term. The relinearization key is used to eliminate the third term and obtain a pair of ciphertexts (c0×c′0, c1×c′1). Note that the cleartext multiplicative identity, one, encodes to a random polynomial in ciphertext, but the homomorphic properties operate such that the encrypted ciphertext of a multiplicative identity is also a multiplicative identity in the encryption domain.

Rotation of cleartext vector by one position [A B C D] yields rotated vector [D A B C]. Using homomorphic rotation function 542 on input vector E([A B C D]) 540 results in rotated encrypted vector E([D A B C]) 544. The implementation of encrypted rotation will depend on the encryption scheme deployed. If a vector is encrypted into a vector of discrete encrypted values, e.g., E([A B C D])=[E(A) E(B) E(C) E(D)], then those discrete encrypted values are accessible and can be reordered directly. CKKS allows such value-by-value encryption, as do other encryption schemes such as the ElGamal cryptosystem. CKKS also provides for batch encryption of vectors. In the exemplary embodiment, batch encryption is used, so each element is not accessible individually in the encrypted domain. As detailed further below, rotation can be useful for a variety of validating and analysis computation on such batch-encrypted vectors. In CKKS, the Galois key is used to rotate the encrypted vector values.

Signum function SGN(X) 552 operates on an encrypted vector input 550 to produce encrypted output vector 554. For each value x in the input vector, the output is replaced with sgn(x):

$$sgn ( x ) = \{ \begin{matrix}- 1 , & x < 0 \\ 0 , & x = 0 \\ 1 , & x > 0\end{matrix}$$

An illustrated encrypted input vector 550, invalid poll response [−20 10 7 0], is passed through SGN(X) 552 yielding E([−1 11 0]) 554.

Signum can be computed for real numbers in a variety of ways, for example, |X|/X or sqrt(X)²/X. In the example embodiment, poll response vectors are encoded and encrypted into a pair of polynomials, as described above. Discontinuous, non-polynomial functions such as square root and inverse aren't directly applicable in polynomial form. Instead, a polynomial approximation of the signum function is used to perform the same operations in the encrypted domain.

The Remez algorithm in the range [−1, 1] is one suitable approximation to produce the signum function for polynomials. In general, to find a polynomial approximation of a given function f(x) on an interval [a, b] where its values on a finite set of points are known, an interpolation polynomial that passes through these points is determined. To find an optimal approximate polynomial, the error between the approximated polynomial and the function is measured, which is called a minimax polynomial. Optimal approximation is found to minimize the maximum error between the function and the approximated polynomial, iteratively. In embodiments of methods detailed below, a polynomial approximation to the signum function is generated using the Remez algorithm and stored. This approximate polynomial (R) is useful in the verification process.

A squaring function (X)² 562 is useful for squaring encrypted input vector 560 to produce encrypted output vector 564. To illustrate, the vector resulting from the SGN(X) 552 process produced E([−1 11 0)]. When this result is fed through squaring function 562, any remaining negative values will become positive. In this illustration, the output is E([1 11 0]).

Returning to FIG. 4, ciphertext 450, E(f(m)), is the result of computations f(c) 440. Ciphertext 450 can be decrypted into plaintext 460 using the private key by the owner of the key-pair generator. The decrypted polynomial is then decoded into the resultant vector, in this example f(m) 470. Thus, the cleartext message m, having been encoded and encrypted into ciphertext c, is manipulated homomorphically with function f(c). As a result, the decrypted result is f(m), the original message as if it had been manipulated in cleartext.

The following examples include results showing arrays of votes and analysis vectors in cleartext. But, as detailed below, since the operations take place on and results are delivered in ciphertext, in accordance with homomorphic principles, the illustrative examples show the results of the operations as if they were performed in cleartext on the cleartext data represented by the encrypted results. In other words, these show the results if, at any stage, the encrypted data were decrypted and decoded. However, only the possessor of the appropriate private key can decrypt, and in the example embodiments the validation and analysis engines detailed do not have such keys accessible, by design.

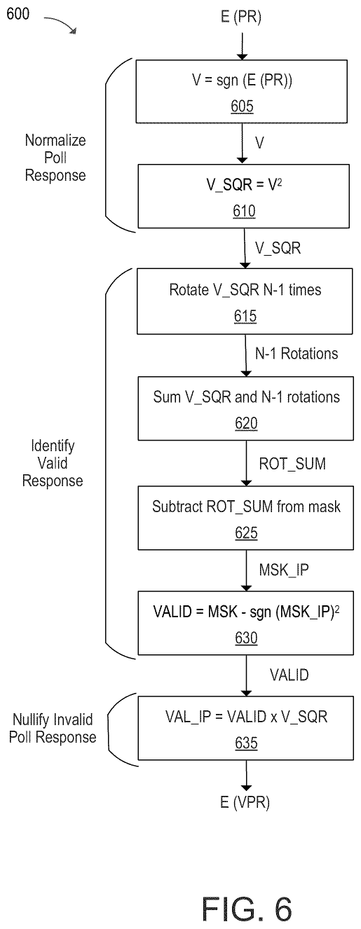

FIG. 6 is a flowchart depicting an example method 600 of validating encrypted poll responses to produce encrypted validated poll responses. The validation process has three basic phases to produce validated poll responses from received poll responses, all performed in the encrypted space. First, the poll response is normalized, so that all underlying values in the response are ensured to be positive numbers of a desired magnitude. In the example embodiment, the desired magnitude is one (in the underlying data represented by the ciphertext), or a multiplicative identity in ciphertext. The normalizing phase removes any invalid weighting from a poll response. In the second phase, the poll response is identified as valid or invalid, meaning it has only one choice selected for a corresponding ballot question. Finally, invalid poll responses are nullified.

In the example embodiment, the normalization phase of validation is performed taking the signum function (605) of an encrypted poll response E(PR) (a vector of size N) to produce an intermediate result V (also a vector of size N), with values consisting of only 1, 0, or −1. Then V is squared (610) to produce V_SQR, removing any negative values. Thus, V_SQR is a normalized version of the encrypted poll response.

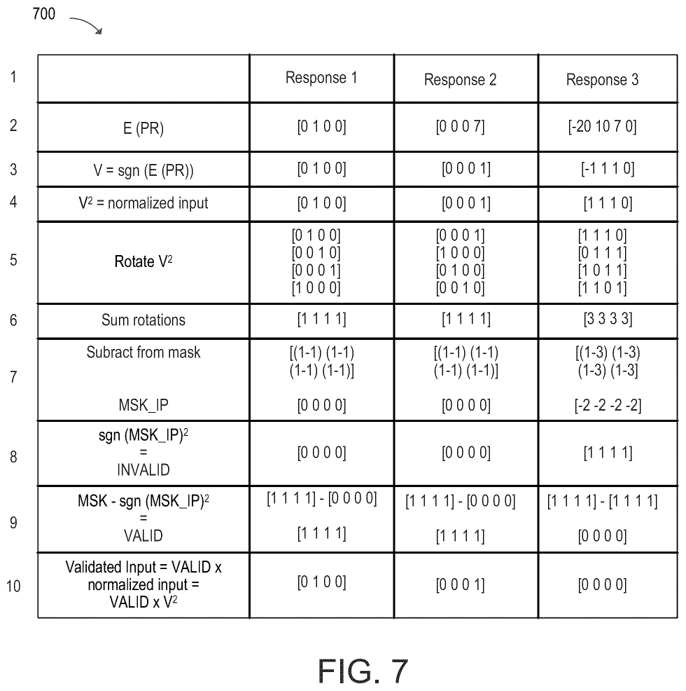

The method can be understood in conjunction with FIG. 7, which includes table 700 illustrating method 600 applied to sample encrypted poll responses. As shown in row 2 of table 700, the earlier examples of input vectors are used for E(PR): a valid response 1 [0 1 0 0], an overweight response 2 [0 0 0 7], and an invalid response 3 [−20 10 7 0]. In row 3, the signum function of the valid response [0 1 0 0] is, naturally, identical, as is its square, shown in row 4. The overweight response [0 0 0 7] becomes [0 0 0 1] after the signum function and is now a valid response (as is its square). The invalid response [−20 10 7 0] becomes [−1 11 0] after the signum, and its square is [1 1 1 0]. All the responses are now normalized (see row 4), as each value is either a 0 or a 1, however all responses are not valid, as response 3 has too many choices selected.

Recall that the values in table 700 are shown in cleartext for illustrative purposes. The actual values for V_SQR are sets of encrypted polynomials which, if decrypted, would yield the values shown. The normalization process was applied to all three vectors, resulting in two valid responses and an invalid response, but there is no way to determine if any of them are invalid or valid without decrypting. As detailed further below, in the example embodiment, a validation engine is deployed to perform the validation task on encrypted poll responses, and the entity comprising the validation engine has no access to the key required for decryption. The input vector (row 2) is encrypted by the user using the admin public key. Rows 3 to 10 are carried out by the trusted third party in encrypted form, with no ability to decrypt any of the responses or results. The admin receives only the encrypted vectors after row 10. The admin can decrypt the aggregated poll results, with no information regarding individual responses or user identity. Thus, the poll responses remain completely anonymous, even for a nullified invalid response.

In the above examples, the vote encoding has used a 1 for a selection and a 0 for non-selection. However, any number could be substituted. For example, if a valid vote was [0 3 0 0](for response 1), then a seed mask can be generated as [1/3 1/3 1/3 1/3] and multiplied by votes to normalize before processing. Or consider an encoding scheme that inverted the vote encoding, such that a 0 denoted a selection and a 1 denoted non-selection, e.g., a valid vote for response 1 would be [1 0 1 1]. In this case, generating a seed mask of [11 1 11] and subtracting the vote would produce the normalized vote input [0 1 0 0]. Similarly, a combination of the two, using a 3 for a non-selection and a 0 for a selection (e.g. [3 0 3 3] could be normalized by generating two masks, and multiplying votes by the encryption of [1/3 1/3 1/3 1/3] and subtracting the result from encrypted mask [1 1 1 1] would yield the encrypted version of valid vote [0 1 0 0]. Those of skill in the art will recognize there are any number of design options to include in a recipe for encoding a vote result, and, knowing that recipe, an appropriate pre-validation mask sequence can be used to normalize the votes (and thus be processed using the [1 1 1 1] default mask. Furthermore, normalization could occur in other steps of the process, e.g., prior to 635. Any of these alternate example schemes would yield the same results for responses 1, 2, or 3, after validation.

The second phase of validation is to identify which responses are invalid. Again, as all the computations are performed on ciphertext in the encrypted domain, the identification is not available to the validation process. However, in the encrypted space a response can be identified as valid when only a single non-zero value exists in the vector (a single choice) or invalid when there are more than one.

As detailed above with respect to FIG. 5, Galois key rotation can be used with CKKS encrypted poll responses. In this example, the normalized poll response, V_SQR, is rotated N-1 times (615). The N-1 cyclic rotations along with V_SQR comprise all the permutations of V_SQR. The results for each example response are shown in row 5 of table 700. The permutations are then summed (620) to produce ROT_SUM. All poll responses votes will have a ROT_SUM comprising a vector of size N containing N values equaling the number of choices selected (e.g., votes cast). Valid poll responses, having just one selection, will have a ROT_SUM of all ones. Invalid votes will have values greater than one. Row 6 illustrates this. Response 1 and 2, the valid responses, have a sum of rotations [1 1 1 1], whereas response 3, the invalid response, has [3 3 3 3], where 3 represents the number of choices selected in the invalid vote.

While ROT_SUM is an indication of which responses are valid, further processing can yield a valid indicator that can be used in homomorphic computation. A mask vector MSK is a vector of size N comprising values of the desired magnitude, set to one in the example embodiment. The sum of rotations, ROT_SUM, is subtracted from the mask MSK (625) to produce MSK_IP. The example results are shown in row 7. Since the sum of rotations for all valid votes will be [1 1 1 1], which is identical to the mask, then MSK_IP will be [0 0 0 0] for all valid votes. Invalid votes, whose sum of rotations include values greater than one, will result in an MSK_IP with negative values. Taking the signum of MSK_IP and squaring the result normalizes MSK_IP, in similar fashion as described in 605 and 610 above (see row 8). For valid poll results, MSK_IP of [0 0 0 0], the result remains [0 0 0 0]. For invalid poll results the result will be [1 1 1 1]. This can be described as an indicator of invalid results. To determine a positive indicator of valid results, subtract sgn(MSK_IP)² from the mask MSK (630). As shown in row 9, all valid votes have a VALID vector of [1 1 1 1], which is a vector comprising multiplicative identity values. All invalid votes result in a VALID vector of [0 0 0 0].

The last phase of validation is to nullify invalid results. Again, the VALID vector is represented in table 700 by a cleartext [1 1 1 1] or [0 0 0 0], but the actual VALID vector is a ciphertext polynomial. Given that the encryption is homomorphic, the VALID vector encrypting [1 1 1 1], or E([1 1 1 1]) is itself a multiplicative identity vector in ciphertext. And the VALID vector encrypting [0 0 0 0], or E([0 0 0 0]), is an additive identity vector in ciphertext. Therefore, multiplying any encrypted vector of size N by a VALID vector of size N, when VALID represents [1 1 1 1] will result in an encrypted vector of the same “value” albeit with a different ciphertext polynomial. That is, it would decrypt to the original vector value. Similarly, multiplying any encrypted vector of size N by a VALID vector of size N, when VALID represents [0 0 0 0] will result in a ciphertext additive identity vector, that is, an encryption of the vector [0 0 0 0](based on the property of multiplying the original vector by zero).

A validated poll response, E(VPR), is therefore computed by multiplying the normalized input V_SQR by the validity identifier VALID (635). Example results are shown in row 10. All valid poll responses will have their normalized values unchanged, as they were multiplied by the multiplicative identity. All invalid poll responses will have their values nullified, that is, set to zero in cleartext, and set to an additive identity vector in ciphertext. Again, invalid poll responses and valid poll responses are not distinguishable in ciphertext. However, each nullified poll response is now an additive identity vector, and so can be included in any summing procedures without changing the aggregate results.

In an alternate embodiment, in which an encryption scheme is used that allows access to each value of a poll response independently, then a similar but simpler version of validity identification and nullification can be deployed. While it is possible to directly rotate the accessible independent values and process them in the same fashion, they can more simply be summed directly. That encrypted sum could be subtracted from the encryption of the value one, which would result in a negative number for all invalid poll responses (more than one choice) and zero for valid poll responses (exactly one response). Normalizing with signum and squaring that number will result in a 0 for valid poll results and a 1 for invalid poll results. Subtracting from 1 then gives a scalar valid indicator, which can be multiplied by normalized poll results to retain valid votes and nullify invalid votes.

The foregoing description has focused mainly on determining a valid encrypted poll response from a response to a single ballot question with N choices. The same principles can be expanded to ballots containing any number of queries of varying choice size. Each query response can be validated as just described. A variety of types of analysis can be performed on the validated poll responses, all while they remain in their encrypted form.

In many instances, it may be desirable, as already discussed, for poll responses to be disconnected from the user's identities, to provide anonymity, although this is not a requirement. In either case, further analysis can be performed on poll responses with respect to any number of user parameters. These user parameters will be associated with a user's poll response and can be stored in cleartext. If anonymity is not required, the user identification could be stored with the vote, and the tamper-proofing qualities of the methods described would still apply. Otherwise, pseudonymized or other data may be associated with a response, such as gender, age, location, nationality, employment status, or any other parameters available for users. Users may be people, but could be related to organizations, or any other group of items for which responses to questions about their attributes would benefit from encryption. These parameters can be stored in cleartext in an example embodiment. Analysis of the poll responses can be made with respect to one or more of the parameters. For example, a total of votes cast for each of a plurality of candidates by e.g., only women can be determined.

Additionally, analysis of the relationship between responses to a first question with one or more other questions can be made, so called co-relation. For example, consider a poll in which a user is asked to select a position on a current important political question, as well as to vote for a candidate for public office. The poll responses can be analyzed to determine whether people who feel one way on the political question tend to vote for a particular candidate, and so forth. Multi-question relationship analysis can be combined with parameter analysis as well. For example, the same question regarding views on a political question and candidate selection can be limited to responses from women only.

As processing is done on the encrypted data, per the characteristics of homomorphic encryption, there are errors and noise introduced in the output of such processing. The leveled homomorphic schemes are adequate to support fewer computations, and hence admissible errors or noise, in addition and multiplication operations. When there is a need for higher level of analysis, and additional computation involved, bootstrapping is invoked to lower the noise from the processed output.

Analysis can be conceptually categorized in four basic types, although there are any number of subvariants. Type I analysis is the most basic, it is a simple homomorphic summation of all the validated encrypted poll responses. Recall that a validated poll response is not necessarily valid. Rather, each of a group of validated poll responses is either a valid poll response or is nullified. As such, to get a total count of each response choice from the group, all the validated poll responses are included in the summation (and those nullified will not affect the results).

Type II analysis is performed using one or more cleartext parameters to selectively combine a subset of validated poll responses. For example, all poll responses for each gender can be summed, respectively. Type I analysis is a subset of Type II, wherein no parameter is used for selection, or, in other words, the parameter for selection is “all”. In both cases, the computations are based on homomorphic summing of the poll responses directly.

Type III and IV analyses require computation that interacts with values in the encrypted domain. Type III processes in response to cleartext parameters by creating encrypted versions of those parameters and performing computation with them and the encrypted poll responses. Type IV computes relationships between two or more encrypted poll responses, all within the encrypted space. Types II, III and IV can be combined in any fashion. In all these examples, some or all of the computations are performed on encrypted data, and the results are also encrypted.

The encrypted analysis results, in the example embodiment, are produced in a first computational device without access to the decryption key associated with the encrypted data. The encrypted results are made available to a second computational device, having the key, for decryption. The encrypted data, such as the individual encrypted poll results, are not made available to the second computational device. In this way, anonymity is preserved, by preventing the first device from having the means to decrypt and restricting the second device from any results other than pseudonymized or aggregate data.

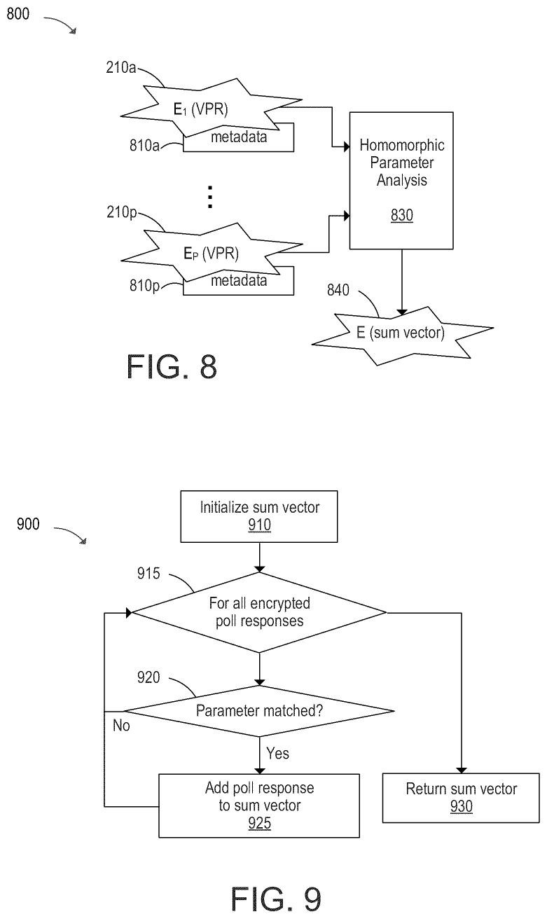

FIG. 8 is a system 800 which illustrates homomorphic analysis of encrypted poll responses in accordance with cleartext metadata. This is an example of type II analysis. A group of P encrypted validated poll responses 210a to 210p are associated with metadata 810a to 810p, the metadata including one or more parameters of the respective user. The validated poll responses 210 and associated metadata 810 are processed by homomorphic parameter analysis 830 to produce encrypted sum vector 840.

FIG. 9 is a flowchart 900 illustrating analyzing validated votes to produce a sum of poll responses based on a cleartext parameter. This is basic type II analysis. A sum vector is initialized (910). For each of the total encrypted poll responses (915) determine whether a selected parameter is matched for the poll response (920). Add the poll response to the sum vector when its parameter matches (925) and loop to the next poll response otherwise. When all poll responses are processed, return the encrypted sum vector (930).

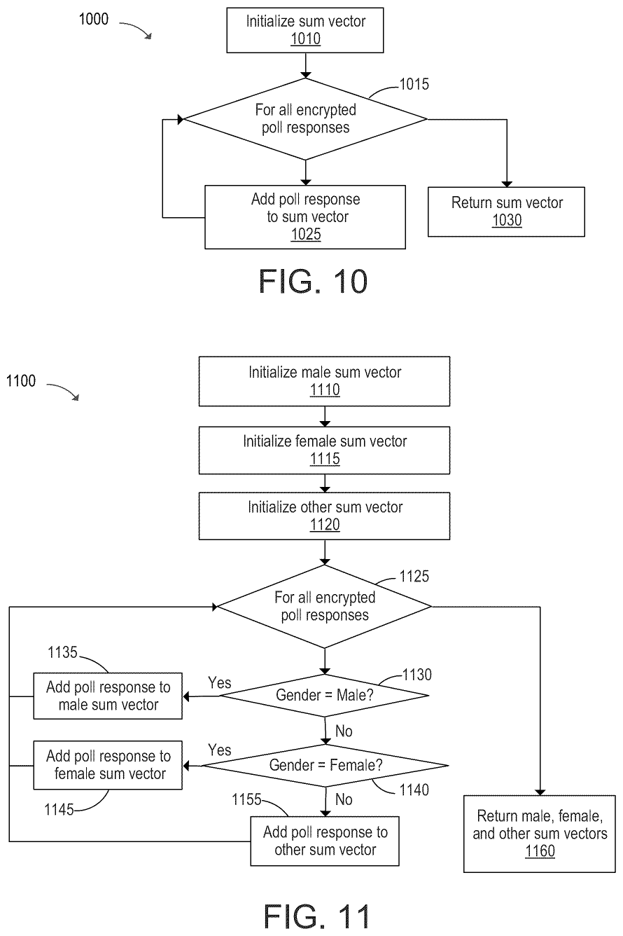

FIG. 10 is a flowchart 1000 illustrating a method for homomorphic computing of the total response to a poll. This is type I analysis, a subset of type II. It is similar to flowchart 900, although no parameter is used for selection, but rather all the votes are totaled. A sum vector is initialized (1010). For all validated encrypted poll responses, add the validated encrypted poll response to the sum vector (1025). Return the sum vector (1030) when all the poll responses are processed. For example, consider a poll consisting of a ballot with four candidates: A, B, C, and D. The respective valid votes for each candidate are [1 0 0 0], [0 1 0 0], [0 0 1 0], and [0 0 0 1]. Consider a group of P=200 voters, casting 42 votes for candidate A, 73 for candidate B, 22 for candidate C, and 52 for candidate D. Assume 11 votes were invalid. The plaintext arithmetic for the voting totals would be 42×[10 0 0]+73×[0 10 0]+22×[0 0 10]+52×[0 0 0 1]+11×[0 0 0 0]. The votes, encoded, encrypted, validated and homomorphically summed, yield the result E([42 73 22 52]), wherein each column is the respective total for candidates A through D.

FIG. 11 is a flowchart 1100 illustrating a method for homomorphic analysis of poll data using multiple cleartext parameters to return sum vectors for each of those parameters. This is also similar to flowchart 900, but in this case, the poll results are analyzed for more than one parameter. The parameter could be any parameter. For example, consider the same poll described with respect to FIG. 10. Assume further that metadata for gender is associated with the poll responses, with a gender parameter comprising one of male, female, or other. Candidate A received 27 votes from users identifying as male, 10 from users identifying as female, and 5 votes from users identifying as other (O). Candidate B received 20, 50, and 3, based on the gender parameter, respectively. Candidate C received 11, 11, and 0. Candidate D received 30, 10, and 12. The rest of the votes were invalid.

Initialize a male sum vector (1110), a female sum vector (1115), and an other sum vector (1120). For all encrypted validated poll responses (1125), if the gender parameter is male (1130) then add the poll response to the male sum vector (1135). When the gender parameter is female (1140), add the poll response to the female sum vector (1145). Otherwise, add the poll response to the other sum vector (1155). Any of the invalid votes (unidentifiable to the analysis process operating in the encryption domain) have already been nullified, so, regardless of gender, when they are added to any of the sum vectors, they will not increase the sum. When all have been processed, return the encrypted male, female, and other sum vectors (1160). In this example, those results will be, respectively, E([27 20 11 30]), E([10 50 11 10]), and E([5 3 0 12]).

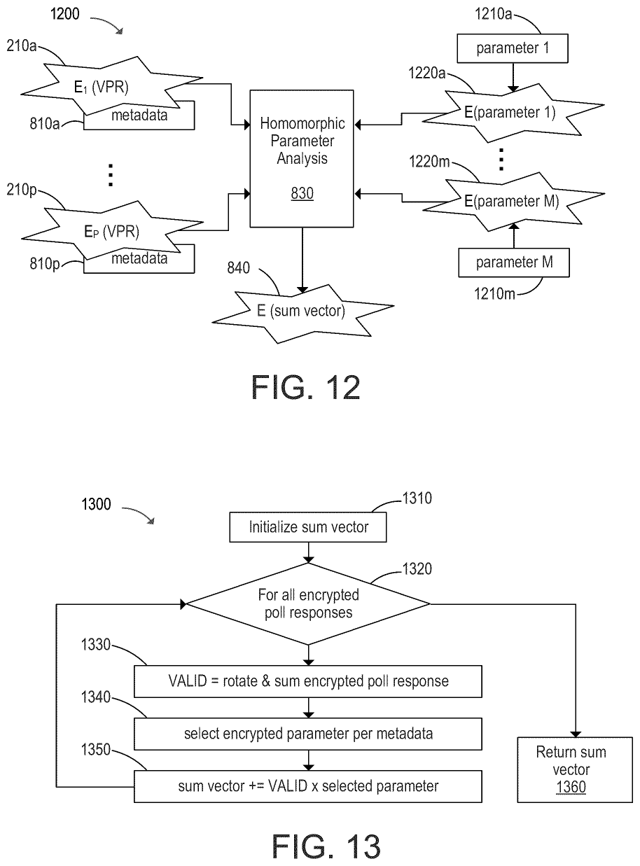

FIG. 12 is a system 1200 which illustrates homomorphic analysis of encrypted poll responses in accordance with cleartext metadata parameters, where parameters are encrypted for use in homomorphic computation of the encrypted poll results. This is an example of type III analysis. System 1200 is like system 800 of FIG. 8, with validated poll responses 210 and respective metadata 810 feeding homomorphic parameter analysis 830 to produce encrypted sum vector 840. In addition, a set of M parameters 1210a to 1210m are introduced. The M parameters are encoded and encrypted to produce ciphertext parameters 1220a to 1220m, which are labeled E(parameter 1) to E(parameter M), respectively. In this system, homomorphic computations are performed with the encrypted validated poll responses 210 and encrypted parameters 1220, in conjunction with cleartext parameters found in metadata 810.

FIG. 13 is a flowchart 1300 illustrating a method for homomorphic analysis of poll results with encrypted metadata parameters. A sum vector is initialized (1310), sized according to the size of encrypted parameters 1220. Several steps are performed for all validated encrypted poll responses in a group (1320). Note that this group could be the entire population of P poll responses. Or, a subset could be processed, by selecting based on a cleartext parameter, such as described above with respect to FIG. 9 (details not shown). For each response (validated and encrypted) in the selected group, a VALID indicator is generated for use in the computation. Rotating and summing all the permutations, as detailed in the validation method 600 above, produces a vector VALID that is a multiplicative identity vector when the response is valid and is an additive identity vector when the response is invalid (1330). In this type of analysis, it is unknown whether the response is valid, but a sum over one or more parameters is desired when it is valid. An encrypted parameter 1220 is chosen from the set of M parameters that corresponds to a cleartext parameter for the user (1340). That encrypted parameter is multiplied by the VALID vector and summed with the sum vector (1350).

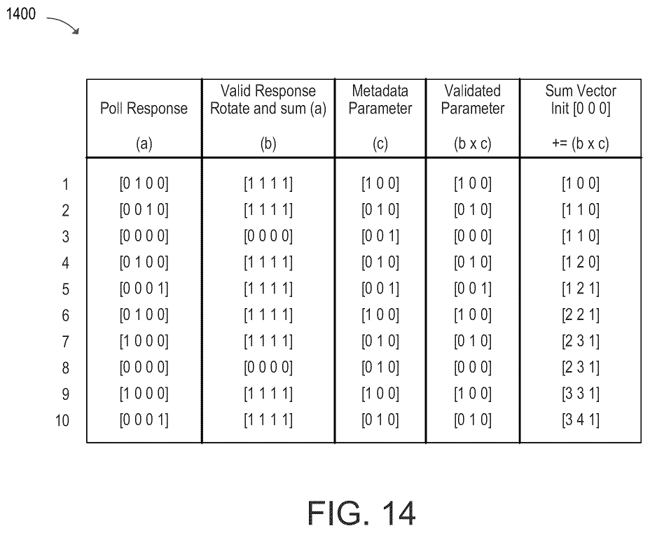

FIG. 14 is a table with example results illustrating the method of FIG. 13. Consider an analysis request to find the number of valid votes cast by gender in a population of votes. In this example, a gender comprising one of “male”, “female”, or “other” is associated with each response in metadata. For the M=3 parameters, encode and encrypt a parameter for each. Let [1 0 0] represent a male user, [0 1 0] represent a female user, and [0 0 1] represent any other user. Then the encrypted parameters for the three genders, respectively, are E([1 0 0]), E([0 1 0]), and E([0 0 1]). The sum vector is initialized to [0 0 0]. In table 1400, there are 10 poll responses (column (a)) with associated computations depicted in rows 1-10. Each response will be identified by its row number. For each response, a valid response is computed by rotating and summing the response (column(b)). All the responses are valid (depicted by [1 1 1 1]) except responses 3 and 8 (depicted by [0 0 0 0]). The gender parameter from the metadata associated with each response is used to select the appropriate encrypted metadata parameter 1220, shown in column (c). The male gender is selected for responses 1, 6, and 9, the female gender is selected for responses 2, 4, 7, 8, and 10, and other gender for responses 3 and 5. A validated parameter is generated by multiplying the valid indicator (column (b)) by the selected gender parameter, and the results are displayed in the 4^{th} column. In all rows except 3 and 8 (corresponding to the valid responses), the validated parameter is simply the selected metadata parameter (as encoded and encrypted). In rows 3 and 8, since the response is invalid, the validated parameter is [0 0 0]. The sum vector holds the tally of valid votes for each of the three genders, in its three respective vector positions. In row 1, a valid male response was received, so the sum vector is incremented in the male (first) position of the vector: [1 0 0]. The second row is a valid female response, so the vector is incremented in the female (second) position: [1 1 0]. The third row is an other-gender response, however, the response is not valid. This is not known to the homomorphic parameter analysis engine, as all these computations are performed on ciphertext, so the validated parameter is summed with the sum vector. However, that value is [0 0 0], so the sum vector remains [1 1 0]. The process continues, as shown, with the appropriate vector position being incremented based on gender (except the next invalid response in row 8), until all the responses are processed. The resultant ciphertext sum vector 840 is returned (1360), which is E([3 4 1]). Upon decryption by an entity with the appropriate key, the sum vector will indicate that 3 valid “male” votes were cast, 4 valid “female” votes were cast, and 1 valid “other” vote was cast.

Note that, when using the CKKS batch encoding scheme, the array size of a batch is fixed once encrypted. So, if a parameter set selected for type III analysis is greater than the size of the poll response, other techniques may need to be utilized. For example, consider a two-choice poll response, where the choices are [1 0] and [0 1]. In this instance, if the validated poll responses are rotated and summed, the result will be [1 1](or [0 0] for nullified responses). If a three-parameter selection vector is used, such as that just described for gender, then homomorphic batch multiplication will lose any votes for the [0 0 1] parameter, or the “other” gender in this example. This is because multiplication of a two-position array results in a two-position array, so the third element is truncated. To avoid this, type IV analysis can be used, where the parameter vector is used in selecting within the encrypted space, as detailed further below. In that instance, the parameter vector is sorted with one or more poll responses in non-increasing order. Another alternative is to encode poll responses with larger vectors, sized at least as large as the largest parameter set desired for analysis, even though the additional positions in the vector will be unused for responses to the respective query.

In an alternate embodiment, poll responses are encrypted in arrays of individual encrypted bits, in contrast with batch encryption in polynomials. In this case, individual values of the response can be accessed, so a simple sum of the array values homomorphically will suffice. Having been validated, the sum equals one for valid responses and the sum equals zero for nullified responses. In this alternative, rather than following flowchart 1300, the analysis becomes like type II analysis as shown in FIG. 11. The sums of values for the poll responses can be tallied according to the cleartext metadata, on gender, for instance, with a separate tally being kept for each. The separate, encrypted tallies can be delivered for each parameter for decrypting by the poll admin or other analysis client.

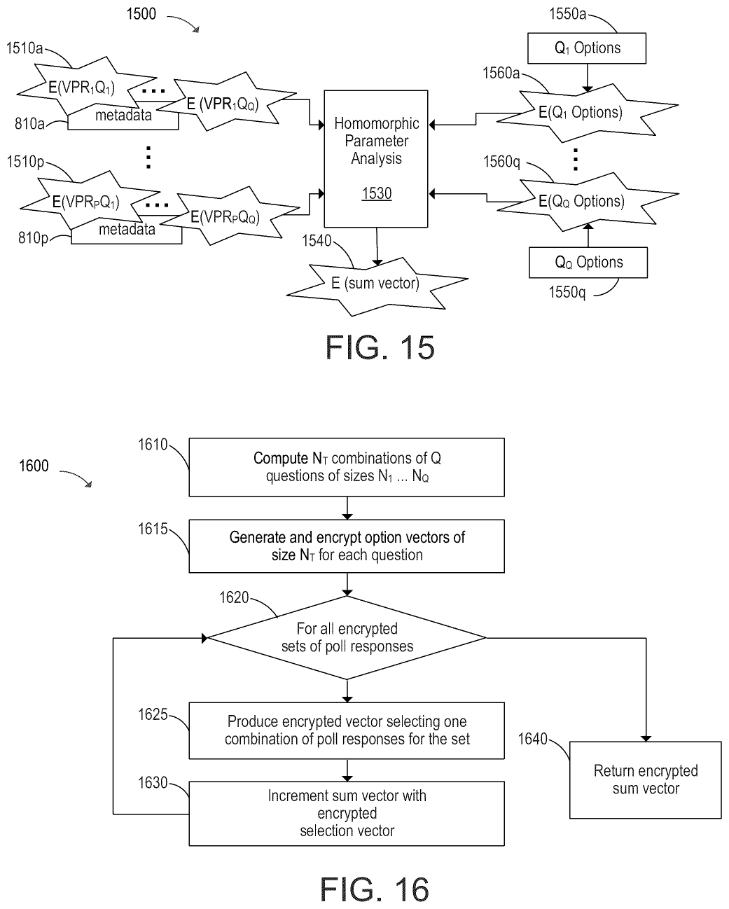

FIG. 15 is a system 1500 which illustrates homomorphic analysis of the relationship between one or more sets of encrypted poll responses. This is an example of type IV analysis. Each user having answered a number of questions included in a poll, it may be desirable to analyze what relationship, if any, exists between poll results for two or more questions. A relationship between two or more poll responses is also referred to as co-relation. Each of P users responds to a poll with Q questions. The sets of responses are encoded, encrypted, and validated, to produce sets of responses E(VPR₁Q₁) . . . E(VPR₁Q_{Q}) 1510a to E(VPR_{P}Q₁) . . . E(VPR_{P}Q_{Q}) 1510p. As with prior examples, as an option, metadata 810 can be associated with each user, and that user's respective set of responses 1510. These responses and metadata are evaluated with homomorphic analysis 1530. When evaluating relationships between responses, the analysis requires access to encrypted data, which is not directly accessible. So, an analysis is performed to determine all the possible combinations of poll responses, and to tally how many of each combination exists in the response pool. This total number of combinations is the size of the sum vector.

To facilitate this, each set of possible responses to each question, Q₁ Options 1550a . . . Q_{Q} Options 1550q are repeated such that the total number of options for 1550 equals the total number of combinations of responses. They are ordered in a fashion to allow any combination of question responses for a user to be homomorphically selected. The results are encrypted to produce E(Q₁ Options) 1560a . . . E(Q_{Q} Options) 1560q, which are available for computation by homomorphic parameter analysis 1530 in the encrypted domain. For each set of responses, one of the total possibilities is identified, and the sum vector is incremented accordingly. As with other analyses detailed herein, invalid votes, having been through the validation process and nullified, are automatically incapable of influencing the sum vector output.

The encrypted resultant sum vector has information about every combination of poll responses. This result can be decrypted by the entity with the appropriate key, and further analysis can be performed on the resultant data. Again, this result has only anonymous or pseudonymous data for the pool of responders.

FIG. 16 is a flowchart illustrating a method 1600 for analyzing the relationship between sets of encrypted responses to questions in a poll, such as described in FIG. 15 above. The process is described using an example to illustrate. In this example, there are two questions in a poll. The first, Q₁, has four choices: A, B, C, and D. The second, Q₂, has three choices: A, B, and C.

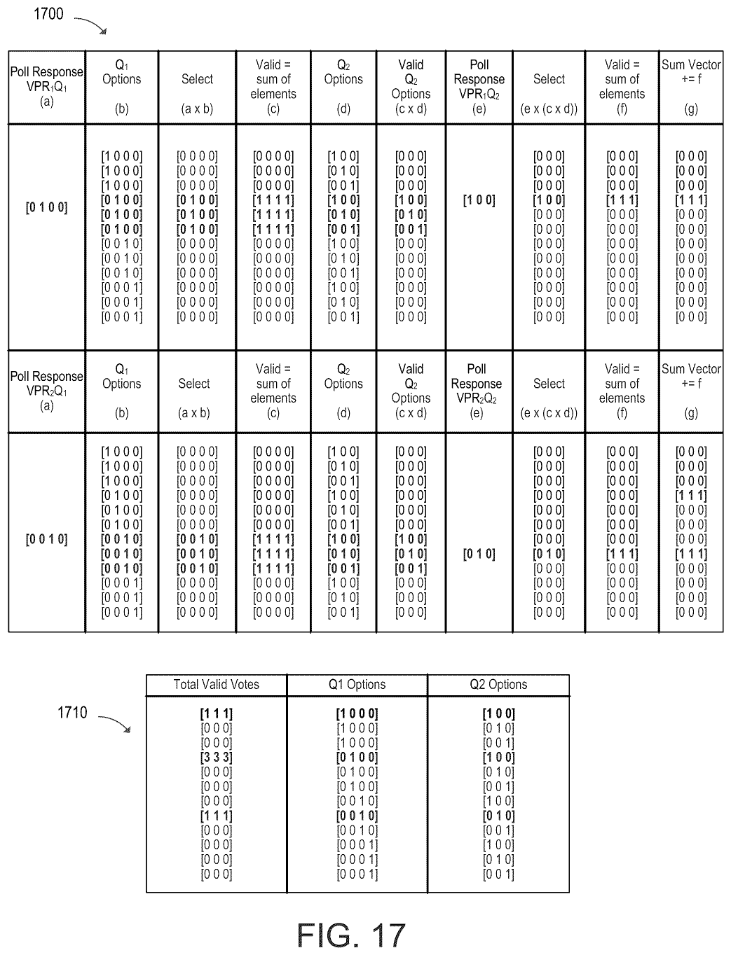

FIG. 17 includes tables 1700 and 1710 with example results illustrating one embodiment of a method 1600. Table 1700 details two iterations of the method. Table 1710 contains complete results for the example analysis query. Again, while arrays of cleartext are displayed in the results of FIG. 17, all the poll response inputs, computations therewith, and results described for method 1600 take place in the encryption domain. For this example, there are P=6 response sets 1510:
VPR₁Q₁'₂ [0 1 0 0] VPR₁Q₂=[1 0 0]
VPR₂Q₁=[0 0 1 0] VPR₂Q₂=[0 1 0]
VPR₃Q₁=[0 0 0 0] VPR₃Q₂=[0 1 0]
VPR₄Q₁=[1 0 0 0] VPR₄Q₂=[1 0 0]
VPR₅Q₁=[0 1 0 0] VPR₅Q₂=[1 0 0]
VPR₆Q₁=[0 1 0 0] VPR₆Q₂=[1 0 0]

Returning to method 1600, the total number, N_{T}, of possible combinations of poll responses in a set is computed (1610) based on the response sizes of each question, N₁ . . . N_{Q}. In general, N_{T} is the product of all the question sizes. For this example, N_{T} is 4×3=12. Next a set of option vectors for each question is generated (1615) of size N_{T}, which is typically larger than any individual question size. Thus, the set of response options for a question will need some sort of repetition. Column (b) shows the Q₁ Options. Each of the four possible choices is repeated three times. Column (d) shows the Q₂ Options. Here the three possible choices are repeated four times, but they are ordered such that each set of three choices corresponds with one repeated column (b) choice. This is not the only order that would suffice. The sets of option vectors should be generated and ordered such that there is the opportunity to select each possible combination of question responses. The vectors are encrypted so they are available for computation in the encrypted domain.

For all the encrypted sets of poll responses in a group (1620), each set associated with a user, produce an encrypted vector selecting one combination of poll responses for the set (1625). The sum vector is then incremented with the encrypted vector. Each position in the sum vector is associated with one combination. In the example embodiment, the sum vector is a vector of arrays, where each array is sized according to the question with the fewest polling options. When the group of responses has been processed (1620), the encrypted sum vector is returned (1640).

Results of processing the first two poll responses of six are shown in table 1700. In this embodiment, the encrypted vector is generated by selecting (at most) one subset of the next question's options based on the question response. The selecting is performed by multiplying remaining possibilities by one and ruled out possibilities by zero. Nullified responses also multiply by zero, thus selecting no subset of the next question's options. As seen in table 1700, the response to the first question for the first user is option B, [0 1 0 0], in column (a). It is multiplied by the Q₁ options in column (b). Only the matching set of three identical options remain, as the other rows will be zero as shown (select column, (a×b)). In column (c), a valid vector is generated. This can be performed by rotating and summing the vector, as described several times above. This valid vector is multiplied by the next question's options, or Q₂ options, column (d), to produce valid Q₂ options. Note that one set including each possibility for question two remain (i.e., non-zero results). This set corresponds to the choice made for question one. The other three sets have fallen away, as their respective options were not chosen. Note further that there is no need to validate options for question one. That is because for the first question no selections have yet been made, so all potential options are still possibilities.

The response to the second question for the first user, choice A [1 0 0](column (e)), is then multiplied by the valid Q₂ options to select the row associated with both responses to questions one and two. This vector is then rotated and summed to generate a [1 1 1] value. This encrypted vector of size N_{T}, with the (at most) one row having non-zero values, is the encrypted selecting vector described in 1625. It can be added to the sum vector, which increments the selected row, as shown. This fourth row in the sum vector corresponds with the combination of choice B for Q₁ and choice A for Q₂.

The process continues for the second user. The Q₁ response, option C [0 0 1 0], is multiplied by the Q₁ options to select the third set (a×b). These are rotated, summed, and multiplied by Q₂ options to select the valid Q₂ options (c×d). Here, the Q₂ response is option B [0 1 0], which is multiplied by the valid Q₂ options to select the row associated with the response set. Rotation and summing results in the selected row being [1 1 1]. Again, this is the encrypted selecting vector, which can be added to the sum vector to increment the selected row, as shown in column (g). Here it can be seen that the previous user's result remains in the fourth row of the sum vector, and the newly incremented row 8 has [1 1 1], signifying the tallying of the combination of choice C for Q₁ and choice B for Q₂.

The process continues for the third user (not shown). Note that third user's Q₁ response is [0 0 0 0], because it has been nullified during validation. Thus, the selecting multiplication (a×b) will result in all zeros, as will all remaining steps. So, the encrypted selecting vector will contain all zeros, and will not affect the values of sum vector when added to it. Any subsequent nullified response after Q₁ would have the same effect for that user as well.

The remaining three responses of the six-response example are processed similarly. The resultant sum vector (1640) is shown as the first column of table 1710. Again, it will be in encrypted form. The Q₁ and Q₂ options can be appended to identify which combination corresponds to the rows in the sum vector column. Those can be appended in ciphertext or cleartext, as the homomorphic parameter analysis engine 1530 has both sets of options, as seen in FIG. 15. The encrypted sum vector is decrypted by an entity with the appropriate key. The results then show that there were 5 valid votes cast (out of six total, so one was invalid). Three combinations were represented, with one vote for choice A for both questions, one vote for choice C and choice B for questions one and two respectively, and three votes for choice B and A, respectively.

In the example embodiment, using CKKS batch processed arrays, individual elements are not accessible in ciphertext. So, as will become apparent in the following examples, the operations need to be ordered such that no data is lost. For example, as described earlier, multiplying a smaller sized vector by a larger sized vector can truncate one or more columns in the results. In this example, if the Q₁ and Q₂ operations were reordered, the valid column (c) would be three elements, and the now Q₁ options of column (d) would be four. The multiplication of (c) by (d) would always lose the last column of (d), so no records of the fourth choice of Q₁ would be tabulated. One solution is to sort the responses and option sets by question size, in non-increasing order. The multiplication does result in smaller arrays as the process proceeds in non-increasing question-size order, as shown. However, the larger arrays (Valid) contain all ones or all zeros, so the selection process integrity is preserved. Other types of encryption schemes may not have these limitations, and thus other operations may be employed to identify a choice set and increment the sum vector accordingly.

It is not required for all combinations of question sets to be analyzed with type IV analysis. For example, perhaps it is desirable to provide just a subset of analysis data to a particular entity making an analysis query. In fact, a variety of different analyses could be generated for a variety of receiving entities (discussed further below). This can be accommodated by simply reducing the options for a question appropriately. As a simple illustration, using the example 4 and 3 choice questions just detailed in FIG. 17, consider an analysis query to determine simply what the total number of responses for each choice of Q₁, but only for those users who responded with choice A for Q₂, [1 0 0]. There is now only one choice for Q₂, so NT would be N₁×1=4. Now the Q₁ options column can simply be the Q₁ possibilities: [1 0 0 0], [0 1 0 0], [0 0 1 0], and [0 0 0 1]. The Q₂ options column is simply choice A [1 0 0] repeated four times. In other words, in table 1700, remove rows 2-3, 5-6, 8-9, and 11-12. The process operates exactly as described above, where the resulting sum vector will have 4 rows corresponding to choices A-D for Q₁. Choice A for Q₂ is inherent. Any responses with a choice other than A for Q₂ will multiply to zero and be discarded in the analysis.

The same technique applies to any subset of choices. The maximum number of possibilities can be generated for analysis, computed as N_{T}, as detailed above, or any subset thereof. For example, 2 of the three choices could be included for Q₂. Alternatively, a single choice for each question may be tested. The analysis is to select only one possible choice for each of a plurality of queries. The resulting vector is incremented only when the exact combination of choice is encountered, as the selection vector will be zero for any other combination.

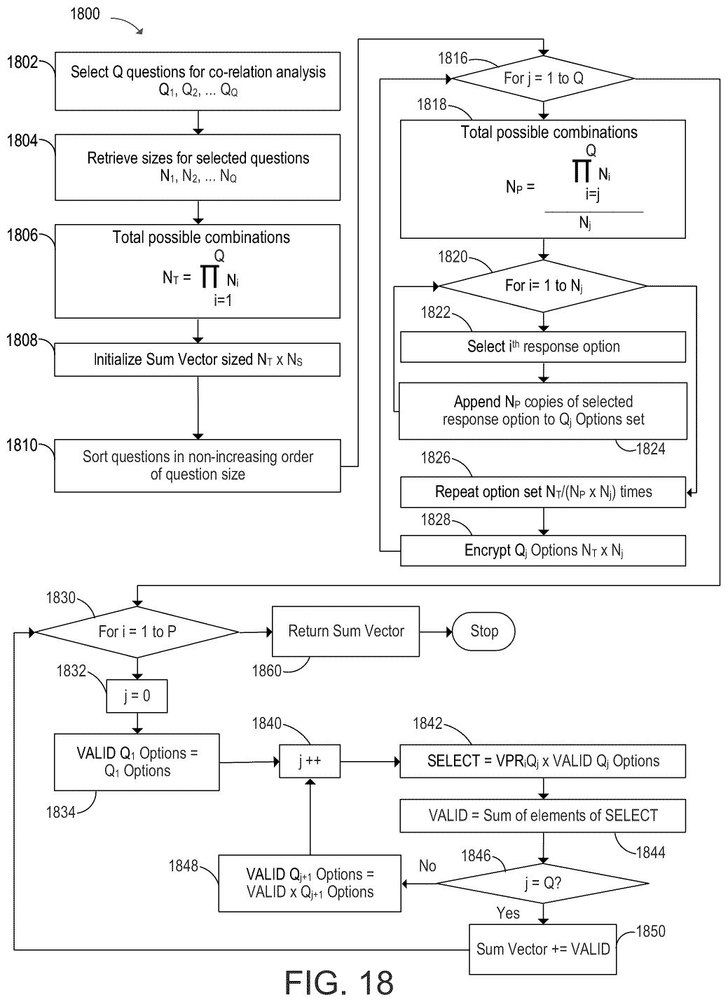

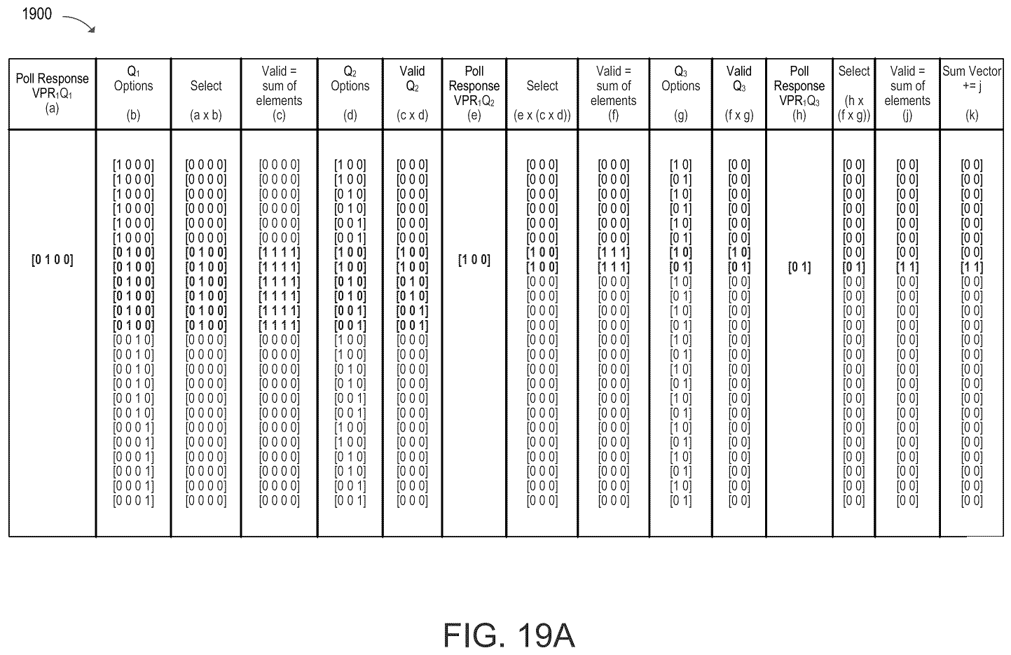

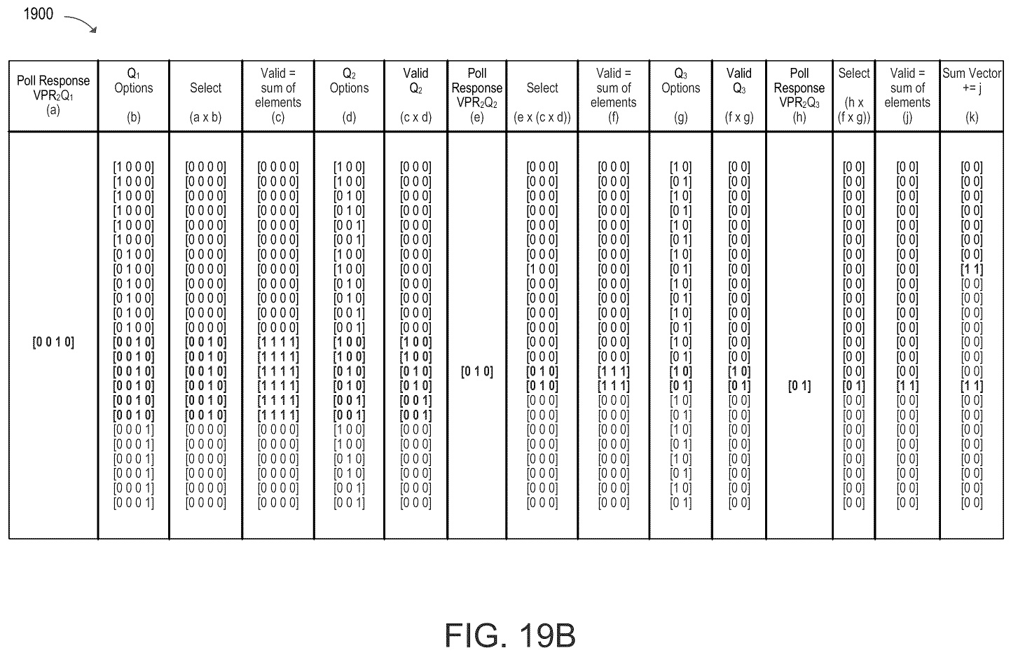

FIG. 18 is a flowchart illustrating a method 1800, an example embodiment of method 1600 or for use in homomorphic parameter analysis unit 1530. Method 1800 can be followed to produce the results shown in FIG. 17, with the two-question co-relation analysis example described above. A new example, with 3 questions for analysis, will be used to further illustrate multiple-question co-relation. FIGS. 19A and 19B include table 1900 illustrating example results for co-relation analysis with multiple questions, in this example 3.

Method 1800 is general, and applicable to any number of questions. The process comprises four main phases: initializing a sum vector sized for total possible combinations, generating and encrypting question option vectors covering response combinations desired for analysis, selecting for each user response set one response combination vector using the encrypted question option vectors, and incrementing the sum vector with the selected response combination vector. Upon completion of the process for a group of users, the sum vector will comprise a tally of each combination of poll responses, in encrypted form. In this example, the analysis will cover all possible response combinations. Any subset from a single combination to all combinations could be chosen for analysis.

For the first phase, initializing the sum vector, select Q questions (1802) for co-relation analysis: Q₁, Q₂, . . . Q_{Q}. Retrieve sizes (1804) for the selected questions: N₁, N₂, . . . N_{Q}. Determine N_{T} (1806), the total number of possible question response possibilities, as the product of N₁, N₂, . . . N_{Q}:

$${N}_{T} = {\prod }_{i = 1}^{Q} {N}_{i}$$

Initialize a sum vector sized N_{T}×Nₛ (1808), where Nₛ is the smallest question size. Nₛ will be N_{Q} when the questions are sorted in non-increasing order. In table 1900, N_{T}=4×3×2=24, and Nₛ is 2, so the sum vector (column (k)) comprises 24 rows of 2-value vectors.

The second phase, generating encrypted question option vectors, produces option vectors for each question. In table 1900, for each of three questions, there are three question vectors in columns (b), (d), and (g), Q₁ Options, Q₂ Options, and Q₃ Options, respectively. Each row is characterized by having a unique set of values in each column. As described earlier, this allows all possible combinations to be accessed in the encrypted domain. However, this layout is just one possibility. The rows can be reordered in any fashion and the property will still apply. It is enough to simply maintain a record of which row applies to which combination, for use when the analysis results are decrypted. Furthermore, any question can have its options reduced to any subset of the choices for that question.

The Q questions are sorted in non-increasing order of question size (1810), question size meaning the number of response options to a poll question, where Q₁ is one of the largest questions, and Q_{Q} is one of the smallest. The poll responses corresponding to the poll questions will be reindexed and accessed accordingly, so that responses remain coupled to respective questions. Note that, rather than sorting and reordering, a poll can be designed such that sets of responses are already in non-increasing order of size, regardless of the order in which questions were presented to any user for response.

In various embodiments, any list of questions can be selected and sorted with questions and responses re-indexed to meet this criterion. Those of skill in the art will readily adapt original sets of validated poll responses to reordered validated sets with simple variable substitution. For example, define former validated poll response sets VPRᵢFQ₁ . . . VPRᵢFQ_{Q}=VPRᵢQ₁ . . . VPRᵢQ_{Q}, the unsorted original sets. Then redefine the variable names for VPRᵢQ₁ . . . VPRᵢQ_{Q}=FVPRᵢFQ₁ . . . FVPRᵢFQ_{Q}, sorted by question size. The map from an original question index FQ to a reordered index Q can be used when the analysis results are decrypted to determine which question combinations correspond to each sum vector value.

To generate option vectors as shown in table 1900, each possible response to a question is potentially repeated to form an option set for that question, the number of repetitions in the set determined by the number of possible combinations of the remaining questions. Loop for all questions, j=1 to Q, (1816) to determine the option set. For each question Q, determine the number of combinations of remaining questions (1818):

$${N}_{P} = \frac{{\prod }_{i = j}^{Q} {N}_{i}}{{N}_{j}}$$

In the example, for Q₁, the number of repetitions, Nₚ, is the multiplication of all remaining question sizes, or 3×2=6. For Q₂, N_{P} is simply N₃=2, since Q₃ is the final question. For Q₃, there are no further questions remaining, so the Q₃ set is simply one of each.

The set is created for each question by looping (1820) for (i=1 to Nⱼ), selecting the i^{th} response option for Qⱼ(1822), and appending Nₚ copies of the selected response to the Qⱼ options set (1824). The set is complete when all question responses are represented, repeated as necessary.

Then the sets are repeated (1826), as necessary, to fill the question option vector with N_{T} options. The number of set repetitions is determined by N_{T}/(N_{P}×Nⱼ). For Qᵢ, N_{T}/(N_{P}×Nⱼ)=24/(6×4)=1. For Q₂, it's 24/(2×3)=4. For Q₃, it's 24/(1×2)=12. Thus, as shown, Qᵢ Options (column (a)) comprises one set of each Q₁ option repeated 6 times. Q₂ Options (column (d)) comprises 4 sets of each Q₂ option repeated twice. Q₃ Options (column (g)) comprises 12 sets of each Q₃ option, not repeated. The Qⱼ Options, sized N_{T}×Nⱼ, are then encrypted (1828) for use in homomorphic selection in the next phase. When all questions are processed and options are generated, j=Q (1816), proceed to the next phase.

In this phase, a response combination vector is selected for each of P poll response sets. The selection is made homomorphically on encrypted data sets using the encrypted question options. In general, for each question, the number of valid remaining question options is reduced by selecting a subgroup of those options with the response to that question. The valid response set gets smaller until the last question response selects a single remaining response vector. At any time during the process, if a response is invalid, having been nullified during validation, then the response vector will be disregarded in the results, as it will be comprised of additive identity values (e.g., zeros in cleartext).

For i=1 to P (1830), each question in the co-relation analysis will be processed. For illustrative purposes, processing a population of P=2 will be detailed in Table 1900 shown in FIGS. 19A and 19B, one for each user, respectively. For this embodiment, selected for illustrative purposes, the loop is initialized with question variable j set to 0 (1832). VALID Qᵢ Options are set (1834) simply to Q₁ Options (Column (b) in table 1900). As described above with reference to table 1700, Q₁ is the first question processed, so all options are still open. In 1840, j is incremented, in this case to 1, and the first question is processed. A subset of the current question options will be selected by the current question response.

The selection is made by multiplying the current question response with the current question options: SELECT=VPR₁Qᵢ×VALID Qᵢ Options (1842). In FIG. 19A, the response for the first question, VPR₁Q₁, column (a), is multiplied by the Q₁ Options, column (b) to produce the Select column (a×b). In this example, the response is [0 1 0 0], which when multiplied by Q₁ Options will yield all zeros, except for the set of matching responses [0 1 0 0]. This subset is highlighted in bold. A valid indicator, for the set of options, is generated by rotating and summing the SELECT vector (1844). It will yield all zeros for unselected options, and all ones for the selected options, as seen in column (c). If j=Q (1846), then the last question for the user has been processed, and the process moves to the final phase (1850). In the current example, j=1, so the valid vector is used to select a corresponding set of options remaining out of Q₂ Options, column (d), by multiplying to produce Valid Q₂, column (c×d). Here it can be seen that one of the four sets of options generated for Q₂, in this case the set associated with the poll response [0 1 0 0](choice B of the first question). To prepare for the next question in the loop, VALID Qⱼ₊₁ Options=VALID×Qⱼ₊₁ Options (1848).

The question loop index j is incremented (1840), and the process repeats for question two. In this example, the second response, VPR₁Q₂, column (e), is [1 0 0](choice A for question two). When multiplied by Valid Q₂ (1842), VPR₁Q₂ selects one of the three subsets of Valid Q₂, the subset associated with choice A. These two selected rows are highlighted in bold. Column (f), Valid, is formed with rotation and summing (1844). Test again (1846) to determine if the last question has been processed, which it has not, so repeat 1848 to set VALID Qⱼ₊₁ Options=VALID×Qⱼ₊₁ Options. In this case, Valid Q₃ is formed selecting just 2 non-zero rows from Q₃ Options. Increment j to 3 (1840) and process the remaining question. As before, multiplying the response to question 3, VPR₁Q₃, column(h), [0 1], by the remaining options, Valid Q₃, selects just one remaining row, which is the row associated with the combination of answers to questions 1, 2, and 3. In this case it is the combination of choice B for question 1, choice A for question 2, and choice B for question 3. The response combination vector is formed by rotating and summing to place all ones in the selected combination row. The rest of the rows will remain zeros following rotation and summing. The loop variable j does now=Q (3), so the processing of questions for user 1 terminates.

The final phase is to update the sum vector with the selected combination vector. When all questions for a user are processed (1846), the selected combination vector is added to the sum vector, where (unless nullified) the row identifying the selected combination will be incremented (1850). This is shown in column (k), where the corresponding row of the sum vector is incremented (and highlighted in bold).

Returning to loop test 1830, there is an additional user response to process, detailed in FIG. 19B. As detailed above with respect to VPR₁Q₁ . . . VPR₁Q₃, the same three questions will be processed with VPR₂Q₁ . . . VPR₂Q₃. In this example, the first question response (column (a)), [0 0 1 0] is multiplied and selects the subset of 6 rows highlighted in bold. The second question response (column (e)) is multiplied and selects the second subset of options, 2 rows highlighted in bold. Finally, the third question response selects the final selected combination vector, highlighted in bold (column (j)). The question processing loop is exited (1846) and the last selected combination vector is used to increment sum vector (1850).

When all users have been processed (1830), the encrypted sum vector comprising the co-relation analysis results is returned (1860), and the process terminates. In this quite simplified P=2 example, column (k) of FIG. 19B contains the sum vector comprising two combinations with a tally of one each, highlighted in bold.

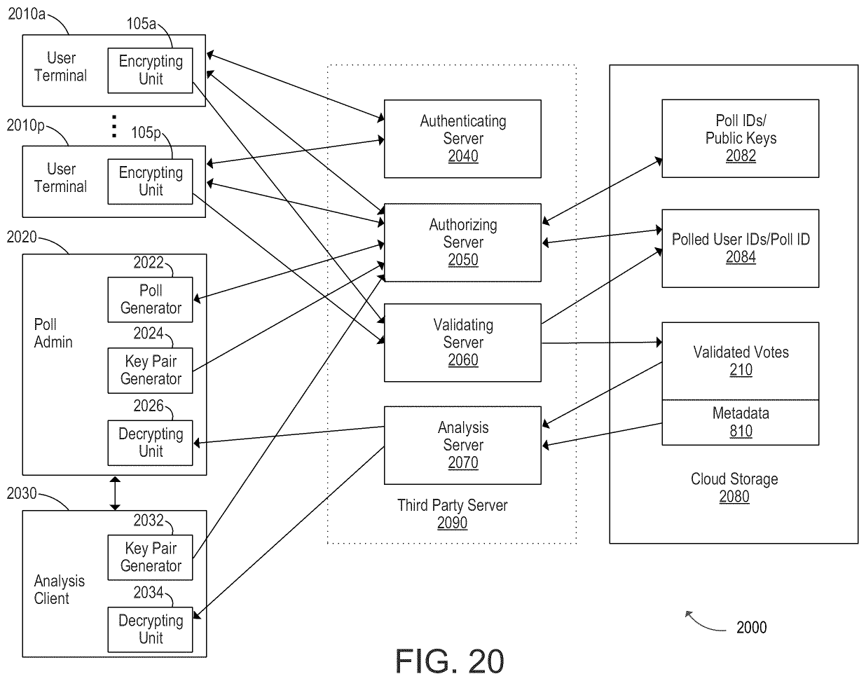

FIG. 20 is an example polling system 2000. Examples and methods of encryption, validation, and analysis have been detailed above, and are suitable for deployment in such a system. In addition, various aspects of and benefits for online polling, including for online voting systems specifically, can be enjoyed when the system is designed with distributed functionality, as illustrated in FIG. 20, and with related figures detailed further below. A poll administrator, or poll admin 2020, initiates the process of creating a poll. It is equipped with a poll generator 2022, a key pair generator 2024, and a decrypting unit 2026.

The poll admin 2020 interfaces with third-party server 2090 to initiate a poll and receive encrypted poll results, including various types of poll analysis. Third-party server 2090 is shown comprising various functions such as authenticating server 2040, authorizing server 2050, validating server 2060, and analysis server 2070. Users participate in the polling system 2000 via user terminals 2010, each of which comprises an encrypting unit 105 for preparing encrypted poll responses. User terminals 2010 interface with various third-party servers 2090. Authenticating server 2040 authenticates the user with a valid identification, authorizing server 2050 authorizes the user to participate in a particular poll, and validating server 2060 receives encrypted poll responses from the user terminal 2010 for validation.

Cloud storage 2080 is connected to third-party servers 2090 to store a variety of information related to poll administration, such as identifications for each poll (poll IDs) and their associated public keys 2082, identifications of users polled (user IDs) for each poll (by poll ID) 2084, validated poll responses 210, and associated anonymous/pseudonymous metadata 810.

Optionally, one or more analysis clients 2030 may communicate with analysis server 2070 to receive poll response analysis for which it is authorized. The levels of poll response analysis can be different for the poll admin 2020 and each analysis client 2030. For example, poll admin 2020 may be allowed access to all poll results and analysis, whereas an analysis client may be provided only with poll results for a desired demographic. Since all results from analysis server 2070 are encrypted, analysis client has a decrypting unit 2034. In some embodiments, analysis client may use a key pair generator 2032 to provide its own public key for encrypting analysis results directed to it. In other embodiments, analysis clients 2030 may cooperate directly with poll admin 2020 to receive private results from it or share the private key. Each entity (whether poll admin 2020, analysis client 2030, or other entity) can receive analysis results tailored for the specific entity, based on any technique.

While the functions of third-party server 2090 may reside in one server, in various embodiments one or more of those functions may be distributed between one or more independent third-party servers. Storage for poll administration is not required to be cloud-based, it could reside on one or more of the various third-party servers 2090. However, it is another design element variable.

System design considerations including security, anonymity, and ease of administration may lead to various configurations, depending on the system requirements. In one example, a key aspect is anonymity and security. Each user encrypts their individual poll response. A third-party processes votes, always encrypted. Cloud storage may be administered by the same entity as server, but that is not necessary. Cloud storage may be made visible, in whole or in part, to one or more entities to provide auditing of results (in encrypted form, according to desired level of anonymity. Entities such as a poll admin, along with optional analysis clients, have access to decrypted data, but only aggregate or pseudonymous in this example. Various entities in alternative embodiments may participate together to provide distributed public key encryption to provide additional security, wherein each entity cooperates to decrypt their respective results. An optional analysis client (or other entities) may use distributed key generation, such that cooperation is required for decryption, allowing for only a single entity to remain trustworthy for the system to remain secure (i.e., all entities would have to collude to cheat). Poll admin 2020 could have access to all analysis, or it can be parsed as desired by analysis server 2070. More specific information can be granted to various entities based on access privilege settings.

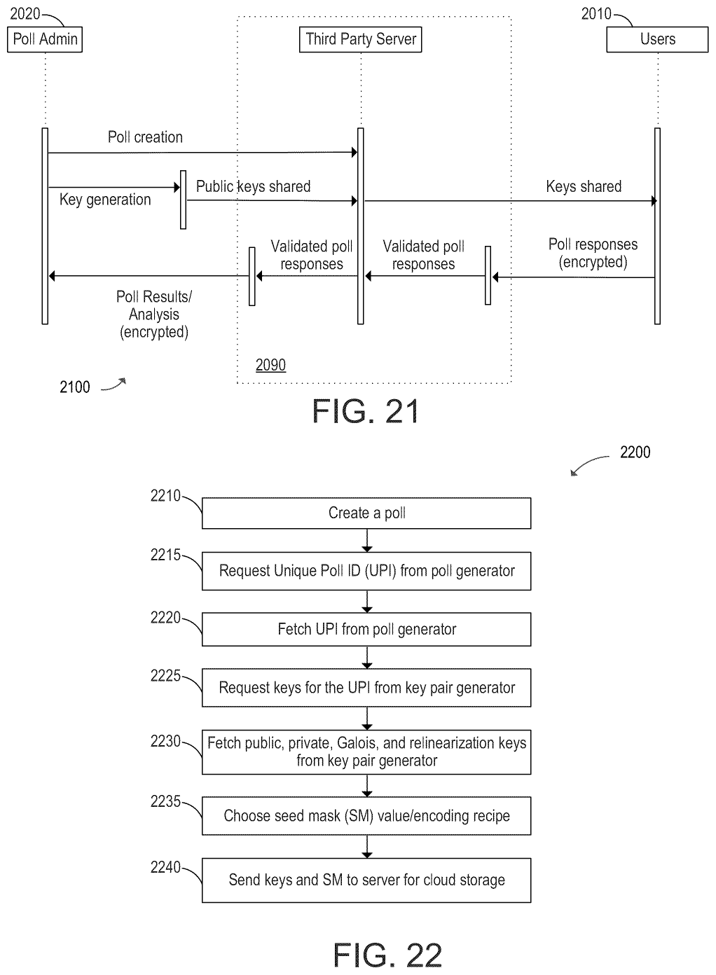

FIG. 21 illustrates a process flow 2100 for polling system 2000. The process flow is divided into five general phases: poll creation, online poll response (voting), validation, analyzing, and results extraction. Poll admin 2020 initiates the poll creation process with third-party server 2090.

FIG. 22 is a flowchart 2200 illustrating an example poll creation process. The poll admin creates a poll form (2210), such as a ballot, survey, or any other set of questions and possible responses. A request is made (2215) to the poll generator 2022 for a Unique Poll Identifier (UPI). Each poll created by the poll admin will have its own unique identifier. A UPI is made and fetched (2220) from the poll generator 2022. A request for keys to be associated with the UPI is made (2225). In the example embodiment, using CKKS, the keys are generated and fetched (2230) including public, private, Galois, and relinearization keys, as detailed above. In the example embodiment, poll responses are encoded as detailed above with respect to FIG. 3, with a response array having a single value of one for the selected choice, and zeros in the other positions. If an alternate encoding is desired, a seed mask can be generated, or other alternate recipe for encoding can be selected (2235). The private key is retained by the poll admin for decrypting results when they are generated. The public and other keys are sent (2240) to the third-party server for storage in cloud storage 2080. The seed mask, and any details necessary to identify the encoding recipe, are stored in the cloud for use when validating votes.

Returning to FIG. 21, the public keys will be shared with users 2010 in the online poll response phase. Users (having been authenticated and authorized) will make their selections in response to the poll, and their poll responses will be encrypted and returned to the third-party server 2090 for validation.

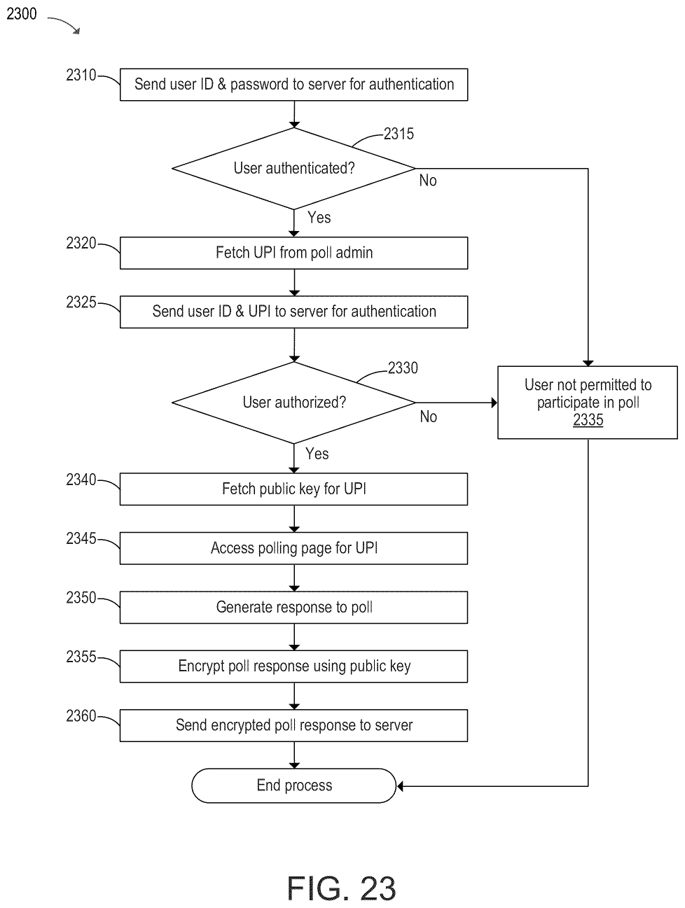

FIG. 23 is a flowchart 2300 illustrating a process for online poll response (voting) by a user. Authentication is a process by which an entity, such as a user in a polling system, proves its identity to the other entities involved in an ecosystem or organization. An entity, once authenticated, becomes a trusted entity in that ecosystem. Any of various forms of authentication may be deployed, such as password-based login, multi-factor, biometric, certificate-based, and token-based. In the example embodiment, to participate in the online polling system, a user sends its identification and password (2310) to authenticating server 2040 via user terminal 2010. If the user fails authentication (2315), the user is not permitted to participate in the poll (2335) and the process terminates.

If the user is authenticated, then a UPI is fetched (2320) associated with the poll in which the user wishes to participate. This may be accessed by the user from the poll admin directly, or the poll admin may supply authorizing parameters to authorizing server 2050 (which may be stored in cloud storage 2080). The user ID and requested UPI are sent (2325) to authorizing server 2050. Authorized users may be included in a list provided, or criteria for authorization may be supplied and compared with attributes of users stored in a database (details not shown). Any authorization procedure to allow and disallow users to participate in polls can be utilized. If the user is not authorized (2330), the user is not permitted to participate in the poll (2335) and the process terminates.

There may be different types of polling types. One may permit polling only once for any user. Another, for example survey forms or feedback forms, may allow users to return from time to time to fill in the forms, and provide progress metrics, until the form is complete and submitted. When an authenticated user requests to poll for a Poll ID, the authorizing server 2050 verifies the eligibility of the user to cast the vote and if the user is eligible, the public key of the corresponding Poll ID is dispatched to the user. This unit ensures that even though the user may be an authenticated user, he/she cannot vote more than the permitted limit. In the proposed method, one vote is permitted per user per poll and hence the poll count is a Boolean value that holds a record of whether the user has cast the vote or not. A true value for poll count value indicates the vote has been cast and a false value represents that the specific user has yet to cast the vote.

In alternate embodiments, other schemes may be implemented, by allowing more than one vote per user. For example, ranked-choice voting allocates a number of points to users which can be distributed among candidates in any fashion so long as the total number of points is not exceeded. In this example, the number of points for ranked-choice voting is embodied by allocating that number of votes for each user. Or, variable weight voting can be implemented, by allowing different numbers of votes to different classes of users, or in varying contexts. The authorizing server 2050 can maintain any set of variables necessary to provide the polling scheme desired.

Once the user is authenticated and authorized, the polling can commence. The user fetches (2340) the public key 2082 associated with the UPI, supplied by authorizing server 2050 as retrieved from the cloud storage 2080. The user accesses the polling page, such as a ballot or survey, from the poll admin directly, or from a poll stored in cloud storage 2080. A response is generated to the poll (2350). The poll response is encrypted (2355) with the public key associated with the poll, using an encrypting unit 105. The encrypted poll response (2360) is delivered to the validating server 2060.

Returning to FIG. 21, the validation phase occurs when validating server 2060 (part of third-party server 2090) receives encrypted poll responses and generates validated encrypted poll responses, using methods detailed above, using homomorphic encryption. In contrast, some prior art systems use zero knowledge proof and partial knowledge proof techniques for validation of votes. As detailed previously, cloud storage 2080 holds all the databases and variables for the online voting process such as poll IDs, corresponding public keys and user IDs. In the example embodiment, poll responses are stored encrypted and there is no mapping the votes with respective user IDs, decoupled to ensure anonymity of the votes. In alternate schemes, this decoupling may not be used. For example, if it is desirable to have a user able to verify their vote, votes may be posted on a public bulletin board, with the encrypted votes authenticated as coming from their respective users.

In the analyzing phase, analysis server 2070 operates on the validated poll responses to generate any counting or analysis requested in encrypted form, using any of the techniques described above. The analyzed results may also be stored in the cloud storage in encrypted form.

The encrypted results are delivered to poll admin 2020 for the results extraction phase. If one or more analysis clients 2030 are deployed, appropriate analysis/results are delivered in encrypted form to those as well. Using the private key generated previously, the poll admin 2020, and any analysis clients 2030, decrypt the results and the various analyses and poll results will be available in cleartext.

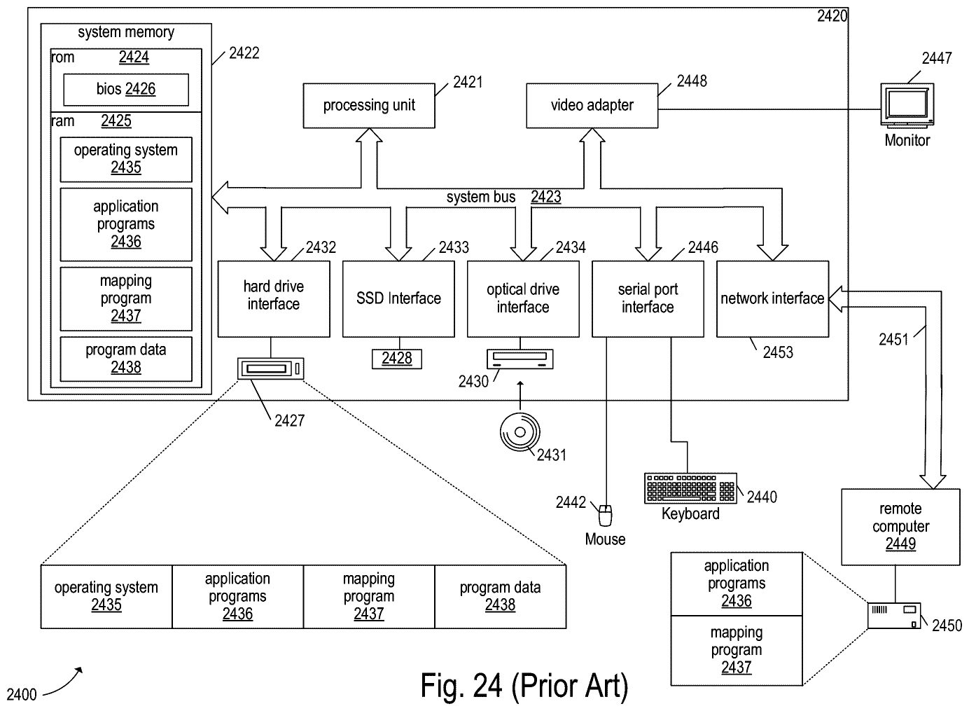

FIG. 24 (prior art) depicts a general-purpose computing system 2400 that can serve as a client or a server depending on the program modules and components included. One or more computers of the type depicted in computing system 2400 can be configured to perform operations described with respect to FIGS. 1 and 2. Those of skill in the art will appreciate that the invention may be practiced using other system configurations, including hand-held devices, multiprocessor systems, microprocessor-based or programmable consumer electronics, network PCs, minicomputers, mainframe computers, and the like. User terminals 2010 can embody any of these forms, for example.

Computing system 2400 includes a conventional computer 2420, including a processing unit 2421, a system memory 2422, and a system bus 2423 that couples various system components including the system memory to the processing unit 2421. The system bus 2423 may be any of several types of bus structures, including a memory bus or memory controller, a peripheral bus, and a local bus using any of a variety of bus architectures. The system memory includes read only memory (ROM) 2424 and random-access memory (RAM) 2425. A basic input/output system 2426 (BIOS), containing the basic routines that help to transfer information between elements within the computer 2420, such as during start-up, is stored in ROM 2424. The computer 2420 further includes a hard disk drive 2427 for reading from and writing to a hard disk, not shown, a solid-state drive 2428 (e.g. NAND flash memory), and an optical disk drive 2430 for reading from or writing to an optical disk 2431 (e.g., a CD or DVD). The hard disk drive 2427 and optical disk drive 2430 are connected to the system bus 2423 by a hard disk drive interface 2432 and an optical drive interface 2434, respectively. The drives and their associated computer-readable media provide nonvolatile storage of computer readable instructions, data structures, program modules and other data for computer 2420. Other types of computer-readable media can be used.

Program modules are stored on non-transitory, computer-readable media such as disk drive 2427, solid state disk 2428, optical disk 2431, ROM 2424, and RAM 2425. The program modules include an operating system 2435, one or more application programs 2436, other program modules 2437, and program data 2438. An application program 2436 can use other elements that reside in system memory 2422 to perform the processes detailed above.

A user may enter commands and information into the computer 2420 through input devices such as a keyboard 2440 and pointing device 2442. Other input devices (not shown) may include a microphone, joystick, game pad, satellite dish, scanner, or the like. These and other input devices are often connected to the processing unit 2421 through a serial port interface 2446 that is coupled to the system bus, but may be connected by other interfaces, such as a parallel port, game port, universal serial bus (USB), or various wireless options. A monitor 2447 or other type of display device is also connected to the system bus 2423 via an interface, such as a video adapter 2448. In addition to the monitor, computers can include or be connected to other peripheral devices (not shown), such as speakers and printers.

The computer 2420 may operate in a networked environment using logical connections to one or more remote computers, such as a remote computer 2449. The remote computer 2449 may be another computer, a server, a router, a network PC, a peer device, or other common network node, and typically includes many or all the elements described above relative to the computer 2420, although only a memory storage device 2450 has been illustrated in FIG. 24 to show support for e.g., various components of system 2000 noted above in connection with FIG. 20. The logical connections depicted in FIG. 24 include a network connection 2451, which can support a local area network (LAN) and/or a wide area network (WAN). Such networking environments are commonplace in offices, enterprise-wide computer networks, intranets, cellular data systems, and the Internet in general. Network connection 2451 may be used to connect to one or more user terminals 2010 (not shown). Furthermore, network 2451 may connect to any number of distributed systems such as cloud-based storage or other web-based applications.

Computer 2420 includes a network interface 2453 to communicate with remote computer 2449 via network connection 2451. In a networked environment, program modules depicted relative to the computer 2420, or portions thereof, may be stored in the remote memory storage device. It will be appreciated that the network connections shown are exemplary and other means of establishing a communication link between the computers may be used.

The foregoing description of the implementations of the present techniques and technologies has been presented for the purposes of illustration and description. This description is not intended to be exhaustive or to limit the present techniques and technologies to the precise form disclosed. Many modifications and variations are possible in light of the above teaching. It is intended that the scope of the present techniques and technologies are not limited by this detailed description. The present techniques and technologies may be embodied in other specific forms without departing from the spirit or essential characteristics thereof. The modules, routines, features, attributes, methodologies, and other aspects of the present disclosure can be implemented as software, hardware, firmware, or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present techniques and technologies are in no way limited to implementation in any specific programming language, or for any specific operating system or environment. Accordingly, the disclosure of the present techniques and technologies is intended to be illustrative, and not limiting. Therefore, the spirit and scope of the appended claims should not be limited to the foregoing description. In U.S. applications, only those claims specifically reciting “means for” or “step for” should be construed in the manner required under 35 U.S.C. § 112(f).

What is claimed is:

1. A method comprising:
performing, by a processing device, a mathematical operation on an encrypted poll response to produce an encrypted result, wherein the mathematical operation applied to the encrypted poll response corresponds to an operation that, when applied to plaintext of the encrypted poll response, changes the plaintext poll response.

2. The method of claim 1, further comprising:
performing the first-mentioned mathematical operation on additional encrypted poll responses to produce additional encrypted results;
performing a second mathematical operation on the encrypted result and the additional encrypted results to obtain an encrypted tally, wherein the second mathematical operation applied to the encrypted result and the additional encrypted results corresponds to an operation that, when applied to plaintext of the encrypted result and the additional encrypted results, sums the plaintext of the encrypted result and the plaintext of each of the additional encrypted results.

3. The method of claim 2, further comprising decrypting the encrypted tally.

4. The method of claim 1, wherein the mathematical operation corresponds to an operation that, when applied to the plaintext of the encrypted poll response, normalizes the plaintext of the encrypted poll response.

5. The method of claim 1, wherein the change nullifies the poll response.

6. The method of claim 1, wherein the change normalizes the poll response.

7. The method of claim 1, wherein the plaintext poll response comprises an integer vector.

8. The method of claim 7, wherein:
the change nullifies the poll response, and
nullifying the plaintext poll result sets the integer vector to zeros.

9. The method of claim 2, wherein each encrypted poll response has an associated plaintext parameter having one of a plurality of possible parameter values, and wherein:
the second mathematical operation is performed on the encrypted result of an encrypted poll response when the plaintext parameter associated with the encrypted poll response equals a selected parameter value of the plurality of possible parameter values.

10. A method for producing an encrypted valid signal for a validated encrypted poll response, the method comprising:
performing, by a processing device, a mathematical operation on the validated encrypted poll response to produce an encrypted valid signal being one of an encrypted first result and an encrypted second result, wherein the mathematical operation applied to the validated encrypted poll response corresponds to an operation that, when applied to plaintext of the validated encrypted poll response, produces the first result as first-result plaintext when the validated encrypted poll response is valid, and produces the second result as second-result plaintext when the validated encrypted poll response is invalid.

11. The method of claim 10, wherein the encrypted first result is a multiplicative identity.

12. The method of claim 10, wherein the encrypted second result is an additive identity.

13. The method of claim 10, wherein the validated encrypted poll response has an associated plaintext parameter having one of a plurality of possible parameter values, the method further comprising:
generating a plurality of encrypted parameter vectors, each encrypted parameter vector associated with one of the plurality of possible parameter values;
selecting one of the encrypted parameter vectors corresponding to the associated plaintext parameter; and
multiplying the encrypted valid signal by the selected encrypted parameter vector to produce a valid encrypted parameter vector.

14. The method of claim 13, further comprising:
producing additional encrypted valid signals for additional valid encrypted parameter vectors;
selecting additional encrypted parameter vectors corresponding to additional associated plaintext parameters;
multiplying the additional encrypted valid signals by the respective additional selected encrypted parameter vectors to produce additional valid encrypted parameter vectors; and
performing a second mathematical operation on the valid encrypted parameter vector and the additional valid encrypted parameter vectors to obtain an encrypted tally, wherein the second mathematical operation applied to the valid encrypted parameter vector and the additional valid encrypted parameter vectors corresponds to an operation that, when applied to plaintext of the valid encrypted parameter vector and the additional valid encrypted parameter vectors, sums the parameter vector with the additional parameter vectors.

15. A method for analyzing a set of encrypted poll responses, wherein:
the set of encrypted poll responses comprises first and second encrypted poll responses, the first encrypted poll response responsive to a first query having a first number of choices, the second encrypted poll response responsive to a second query having a second number of choices; the method comprising:
performing, by a processing device, a mathematical operation on the first and second encrypted poll responses to produce an encrypted result, wherein the mathematical operation corresponds to an operation that, when applied to plaintext of the first and second encrypted poll responses, identifies a response combination of one of the first number of choices and one of the second number of choices.

16. The method of claim 15, wherein the mathematical operation corresponds to an operation that, when applied to the plaintext of the first and second encrypted poll responses, produces a vector having a size corresponding to the size of a set of response combinations, with an indicative value in a position in the vector, wherein the position in the vector corresponds to one of the set of response combinations.

17. The method of claim 15, further comprising analyzing additional sets of poll responses to produce additional encrypted results, performing a second mathematical operation on the encrypted result and the additional encrypted results to obtain an encrypted tally, wherein the second mathematical operation applied to the encrypted result and the additional encrypted results corresponds to an operation that, when applied to plaintext of the encrypted result and the additional encrypted results, tallies the number of identified response combinations.

18. The method of claim 16, further comprising analyzing additional sets of poll responses to produce additional encrypted results, performing a second mathematical operation on the encrypted result and the additional encrypted results to obtain an encrypted tally, wherein the second mathematical operation applied to the encrypted result and the additional encrypted results corresponds to an operation that, when applied to plaintext of the encrypted result and the additional encrypted results, adds the vectors.

19. The method of claim 16, wherein the vector comprises arrays comprised of the indicative value.

20. The method of claim 16, wherein the indicative value is one.

21. The method of claim 15, wherein the mathematical operation corresponds to an operation that, when applied to the plaintext of the first and second encrypted poll responses, identifies a nullified response combination when at least one of the first and second encrypted poll responses is nullified.

22. The method of claim 21, wherein the mathematical operation corresponds to an operation that, when applied to the plaintext of the first and second encrypted poll responses, produces a vector having a plurality of positions, the size of the vector corresponding to the size of a set of response combinations, wherein each position in the vector corresponds to one of the set of response combinations, with a null value in each position in the vector when at least one of the first and second encrypted poll responses is nullified.
